(19) United States
(12) Patent Application Publication
(10) Pub. No.: US 2026/0256057 A1
(43) Pub. Date: Sep. 3, 2026

(54) Flex Draper Float Control on a Windrower

(71) Applicant: MacDon Industries Ltd., Winnipeg (CA)

(72) Inventors: Khurram Mahmood Butt, Winnipeg (CA); James Thomas Dunn, Winnipeg (CA); Ryan Robert Georgison, Balmoral (CA); John Edward Baldwin, Winnipeg (CA); Perry Allan Klassen, Winnipeg (CA)

(21) Appl. No.: 19/552,100

(22) Filed: Feb. 27, 2026

Related U.S. Application Data
(60) Provisional application No. 63/766,288, filed on Mar. 3, 2025.

(51) Int. Cl. A01D 41/14

(52) U.S. Cl. CPC A01D 41/145

(57) ABSTRACT

A windrower includes a header configured as a flex draper for use in windrower field operations wherein a dynamic float control system is provided that dynamically adjusts a float preload in response to changes in height and tilt of the flex draper on the windrower. The float control system allows for the setting of an optimal float that is automatically adjusted in response to changes in header height or changes in system geometry for optimal header performance.

### CROSS-REFERENCE TO RELATED APPLICATIONS

The subject patent application claims priority to, and all the benefits of, U.S. Provisional Patent Application No. 63/766,288, filed on Mar. 3, 2025, the entire contents of which are incorporated by reference herein.

### FIELD OF THE INVENTION

The invention relates to a control system for an agricultural implement, and preferably, to a windrower provided with a flex draper and a float control system for the flex draper that dynamically adjusts the float preload on the flex draper.

### BACKGROUND OF THE INVENTION

Windrowers and combines are distinct types of equipment used in agricultural operations to perform different operations and functions. For example, combines for harvesting a variety of crops from a field are generally known in the art. Combines include headers mounted in front of a respective feeder house. The headers include a cutter bar assembly to cut crop material from the field, and may include a draper belt assembly positioned behind the cutter bar assembly to transport crop material into the feeder house. Further, a reel may be provided above the header and the cutter bar to help sweep crop into the header for cutting. In some cases, the headers may include gauge wheels for supporting the header on the ground.

A variety of hydraulic cylinders may be used to adjust combine components such as the height of the cutter bar assembly. For example, a contour wheel cylinder may extend or retract contour wheels on the header to adjust the height of the cutter bar assembly when cutting above the ground to provide improved performance in comparison to gauge wheels. A header tilt cylinder and/or a faceplate cylinder also may control the pitch of the header relative to the ground during the cutting action.

In known header designs used with a combine, the header may be configured as a flex draper that comprises header segments that can articulate and follow ground contours, wherein an operator may use ground-following contour wheels as a means to control the height of the flex draper while allowing it to follow the field topography, similar to when it is cutting on the ground. When determining appropriate cut height, an operator determines the length of stubble desired and adjusts the height of the contour wheels accordingly.

Despite the use of a flex draper type header on combines in harvesting operations, the use of a flex draper on a windrower effectively has not been possible since the function of a flex and float system on a flex draper requires accurate readjustment of the float with each change in lift height of the header. A common windrower typically includes a coil spring flotation system that counteracts much of the header weight and can achieve ground pressure in the order of 10% of the header mass or weight or less while still having acceptable ground following capabilities. Such spring flotation systems are currently in use on windrowers with rigid headers and other equipment. However, the current float geometry of a windrower results in a decay of float force with each change in height of the header. Further, the weight distribution of the header while cutting off the ground has been uneven as the header was only supported by gauge wheels without the use of adjustable, ground-following contour wheels used on flex drapers. As such, a flex draper type header has not been used on a windrower.

It is an object of the invention to provide an improved windrower which adapts a flex draper for use on a windrower and to inventive methods for controlling the float performance of the flex draper during operation of the windrower.

### SUMMARY OF THE INVENTION

The improved windrower header and windrower operating system therefor comprises a dynamic float control system that configures the windrower to mount and operate a flex draper header thereon, wherein the flex draper is of a type that has been used on harvesting combines but is now modified and configured for use on a windrower through an improved and inventive float control system. As a result, the ground following advantages that result from the use of the flex draper in a combine header application are now applied to swathers or windrowers.

In more detail, the windrower is improved by including a flex draper that incorporates height adjustable, contour-following or ground-following contour wheels or support wheels that can be adjusted to accommodate changes in ground contour and improve performance. One configuration of contour wheels is currently sold by the applicant for this patent application, namely MacDon Industries Ltd., under their ContourMax™ brand. While contour wheels are disclosed herein and while these contour wheels may be described with reference to ContourMax, Cmax or CM, the disclosed contour wheels are not necessarily limited to the specific product offering of the assignee hereof. Generally, the inclusion of these contour wheels with a flex draper design distributes the header load more evenly across these contour or support wheels allowing for improved weight distribution during operation of a combine header over an uneven or undulating ground contour.

The ground-following contour wheels have been incorporated into flex drapers on combine headers, and further are incorporated into the flex draper that is now adapted to be mounted on a swather or windrower. The improved windrower is modified to include the flex draper to allow for use in typical windrower field operations wherein an improved float control system is provided that dynamically adjusts the float preload with height changes of the flex draper on the windrower. Setting an optimal float that is dynamically adjusted in response to changes in header height for a flex draper header on windrower provides an important advantage allowing for optimal header performance. In comparison, with the incorporation of a flex draper in the absence of the inventive float control system, an operator would need to perform an iterative process based on operator's preference with any change in height of the header. This is not ideal since the operator may need to change the height of a flex draper many times in the course of performing an agricultural operation on a field. However, proving the windrower operating system with the dynamic float control system of the present invention overcomes these difficulties as described below.

In more detail as to the flex draper of this type, a float typically is set for the flex draper to counter most of the weight of the header. With the incorporation of a flex draper on a windrower using adjustable contour wheels, the optimal float setting for a flex draper on a windrower is a function of several variables for this flex draper type header, wherein these variables include both the header tilt and the header height from the ground, i.e., the height of a cutterbar off the ground. These variables, including both the header tilt and header height, affect the position of the center of gravity (CoG) of the header relative to boots and the center of rotation of the 4-bar linkage supporting the header, which affect the overall operation of the flex draper.

In this inventive configuration, the header height can be changed by either windrower lift cylinders that raise and lower the flex draper, or by contour wheel actuators that adjust the cutterbar by adjusting the contour wheel positions, or by the combination of both. Therefore, an optimal float setting on the improved windrower is a function of a combination of multiple variables for the flex draper including the tilt setting that adjusts the tilt of the flex draper relative to the windrower and ground, the lift setting for the lift cylinders that adjusts the cutterbar height relative to the windrower and ground, and the contour wheel actuator settings, which also adjust the cutterbar height relative to ground by the contour wheels in contact therewith. Ultimately, these variable settings affect the overall float of the flex draper, which essentially is the percentage of the header weight supported by a float system which in turn reduces the weight of the header or flex draper transferred to the ground through the contour wheels or by contact of the header with the ground. During the operation of the windrower with a flex draper, the float setting may change with changes in other variables as described above. The inventive float control system thereby automates the adjustment of the float setting in response to changes in these other settings, which thereby allows for the simplification of the flex draper operation and accommodates rapid changes in height in the field with minimal loss of float performance and flex performance. Further, the float setting adjustment can be made automatically and dynamically in response to system changes encountered during field operations, such as changes from the flex draper floating upwardly and downwardly in response to ground undulations.

In more detail as to the float system, the windrower uses spring tensioners to counterbalance most of the header or flex draper weight and to thereby maintain the necessary conditions for the flex draper to float effectively during agricultural operations. In the improved windrower, the tensioner spring load is changed using one or more float adjustment cylinders that govern a float link assembly supporting the flex draper on a support frame of the windrower vehicle itself. Preferably, there is one adjustment cylinder per tensioner assembly that may comprise two or more springs and up to four springs per tensioner assembly. In the absence of other changes to the tilt cylinders, contour wheel actuators and lift cylinders in the float system, operating the float adjustment cylinders to extend these float cylinders thereby increases the tension in the spring tensioners and thereby reduces the header's ground force.

In the windrower of the present invention, the windrower includes two support frames, which each connect to a respective support assembly for the header or flex draper comprising a support linkage or float linkage that preferably is configured in the form of a four-bar float linkage. Preferably, one float linkage is provided on each side of the flex draper to independently support the left and right end sections of the flex draper. Each four-bar linkage includes a lift leg, wherein the lower end of the lift leg has forwardly-projecting header supports commonly referenced as the boots that engage with the header to removably mount the header on the windrower. The header is removably mounted to the boots, and the height thereof is adjusted by articulation of each 4-bar float linkage through a respective lift cylinder. A tilt cylinder is also connected between the windrower and header to vary and adjust the tilt of the header relative to the float linkage and windrower. Further, the height of the flex draper can be raised and lowered by the contour wheels. All of these settings affect the governing equation of moment that dictates the header's ground force, which ultimately affects the ground force of the flex draper during field operations.

The float system is capable of carrying most of the header weight, while allowing upward floating of the flex draper relative to the windrower and ground in response to upward forces imparted on the header during typical field operations. Preferably, the lift leg is connected to the header, a float arm is connected to the lift arm and a windrower mount, and extension or tensioner springs are connected between the windrower and lift leg to carry most of the header weight while also allowing upward lifting and downward dropping of the flex draper and cutterbar thereof. A float cylinder is provided to adjust the spring tensioner to thereby adjust a variable spring tension that counters the header weight, wherein a float setting is defined by the spring tension that is set to govern the desired amount header weight to be counteracted by the spring forces. This float setting can be considered the float preload acting on the header. As such, most of the header weight is carried by the float system and the header is able to float or displace upwardly in response to ground effects imparting an upward lifting force that is only a relatively small portion of the total header weight. To monitor the orientation of these structures by the float control system, a float arm to lift leg angle is measured using an indicator sensor configured as a potentiometer mounted on a float link assembly on each of the left and right header sides. The indicator sensor may be considered as one component of the float control system in addition to the float control processes performed on a computer-based controller.

As previously noted, the flex draper also includes a plurality of adjustable contour wheels that provide ground following support to the header, wherein the header weight carried by the contour wheels to the ground preferably is a small portion of the total header weight since the float system counters most of the header weight.

In operation, the float system is adjusted by the float cylinder to preload the springs and vary the amount of the total weight of the header carried by the springs. The springs counter most of the header weight such that only a portion of the total header weight carried by the contour wheels. As noted above, float setting can be varied by varying the spring preload, while the springs also allow lifting of the header in response to external lifting forces that might exceed the float setting or float support provided by the tensioner springs.

Notably, each combination of changes to the header tilt, contour wheel height, and header lift, along with other ground profile influences, thereby affects the relative position of the center of gravity of the header relative to the boots, and the virtual center of rotation of the four-bar float linkage, wherein the changes to these variables thereby varies the float support generated on the flex draper by the float system. Despite the changes to these variables, the float setting for the float system preferably should be set at an ideal float setting, which can be dynamically adjusted in response to ground affects to provide substantially consistent performance of the header and particularly a header configured as a flex draper. Any change in any one of those variables, therefore, corresponds to a unique float adjustment cylinder setting for maintaining an optimal float for the flex draper.

To maintain automatic adjustment of the float setting during field operations, the inventive float control system is configured to read and monitor the contour wheel setting, which defines the cutter bar height relative to ground, the tilt setting governing the tilt of the header by the support linkage, and the float arm to lift leg angle indicating the lift of the header controlled by the lift cylinder. The float control system comprises and preferably relies upon one or more control curves that are used in one aspect to adjust the lift of the header using a Lift-Contour Wheel curve to avoid exceeding the middle of the float range by a significant amount. The float control system further adjusts the optimal float setting based on one or more appropriate optimal float setting curves, the header tilt, and the float arm to lift leg angle according to the float control logic described herein. Preferably, a Lift-Cmax or Contour Wheel curve and an Optimal Float Setting curve are obtained during operation from the float control system's mathematical model or system data that is incorporated into the control system or accessed thereby.

The dynamic float control system selects the appropriate optimal float setting curve for each of the left and right sides of the header based on the calibrated weight of that header side that is determined using a weight calibration process prescribed to determine the weight of each side of the header, which can vary depending upon the header size and configuration. The weight calibration process uses a calibration curve that relates the weight of each side of the flex draper to the corresponding float arm to lift leg angle when the float cylinders are extended to 100%. The calibration process requires enough spring stiffness to lift the header off of the ground with zero lift and tilt, and with a zero reel fore-aft position and reel height with the header placed in rigid mode. The calibration curve has also been obtained from the float control system's mathematical model. Preferably, the float arm to lift arm angle is monitored on each header side to calibrate the weight of the left and right sides of the flex draper.

In the absence of the inventive control system, a flex draper would not be used on a windrower due to the operating requirements of such flex draper. However, the improved float control system allows use of the flex draper on a windrower since it automatically adjusts the float setting for changes in header orientation, which provides advantages over other types of headers, such as non-flexing headers, that were previously used in windrower applications. As a result, operation of a flex draper on a windrower improves the performance of a windrowing operation such as by reducing the amount of crop that might be lost through land undulations and by maintaining a preferred stubble height for better seed bed preparation for the following year.

Other objects and purposes of the invention, and variations thereof, will be apparent upon reading the following specification and inspecting the accompanying drawings.

### BRIEF DESCRIPTION OF THE DRAWINGS

FIG. 1 is a side elevation view of an agricultural implement configured as a windrower supporting a header, which may be a fixed header or more preferably may be a flex draper shown in FIGS. 5 and 6.

FIG. 2 is a rear perspective view of the windrower without a header.

FIG. 3 is rear partial perspective view of a header support assembly for the windrower comprising two lift linkages and a center link to control header tilt.

FIG. 4 is an enlarged side view of a float assembly for the float linkage.

FIG. 5 is a side view of a flex draper mounted to the header support assembly.

FIG. 6 is a rear view of the flex draper configured with height-extendible contour wheels.

FIG. 7 is an enlarged partial view of the float linkage illustrating a float arm to lift leg angle (FAA), which is variable during windrower operation.

FIG. 8A is a side view of the flex draper and header support assembly showing the flex draper lowered for ground engagement in a first condition with the float arm to lift leg angle FAA at a first angle with the contour wheels unextended.

FIG. 8B shows the flex draper raised or elevated to a second condition by extension of the contour wheels, which thereby increases the float arm to lift leg angle FAA to a second angle with the contour wheels extended.

FIG. 8C shows an orientation of the flex draper adjusted to a third condition by extension of lift cylinders, which thereby decreases the float arm to lift leg angle FAA to a third angle with a lift actuator or cylinder extended.

FIG. 8D shows the float arm to lift leg angle FAA of the flex linkage increasing with a positive increase in ground elevation.

FIG. 8E shows the float arm to lift leg angle FAA of the flex linkage decreasing with a negative decrease in ground elevation.

FIGS. 9A-9C show the effects of ground elevation decreases in a float linkage that does not perform active float control.

FIGS. 10A-10C show the effects of ground elevation decreases in the float linkage when controlled by active float control of the present invention.

FIG. 11A is a float curve showing the ground contact force of a flex draper relative to positive and negative ground elevations for a static float for a specified cut height.

FIG. 11B is a float curve showing the ground contact force relative to ground elevation at a specified cut height for specific values of a variable float setting, tilt setting, lift setting and ContourMax or contour wheel setting.

FIG. 12A shows a Lift_Cmax_Curve or Lift_Contour_Wheel_Curve representing the lift settings relative to a curve of CMax or Contour Wheel Settings.

FIG. 12B is a calibration curve for calibrating the weight of respective left or right sides of a flex draper relative to the float arm to lift angle FAA.

FIG. 13 is a diagrammatic flowchart of a dynamic float control system for the windrower for setting an optimal float setting and dynamically controlling the float settings on the windrower during field operations and header adjustments.

FIG. 14 is an enlarged first section of the flowchart of FIG. 13.

FIG. 15 is an enlarged second section of the flowchart of FIG. 14.

FIG. 16 is an enlarged third section of the flowchart of FIG. 15.

Certain terminology will be used in the following description for convenience and reference only, and will not be limiting. For example, the words “upwardly”, “downwardly”, “rightwardly” and “leftwardly” will refer to directions in the drawings to which reference is made. The words “inwardly” and “outwardly” will refer to directions toward and away from, respectively, the geometric center of the arrangement and designated parts thereof. Said terminology will include the words specifically mentioned, derivatives thereof, and words of similar import.

### DETAILED DESCRIPTION

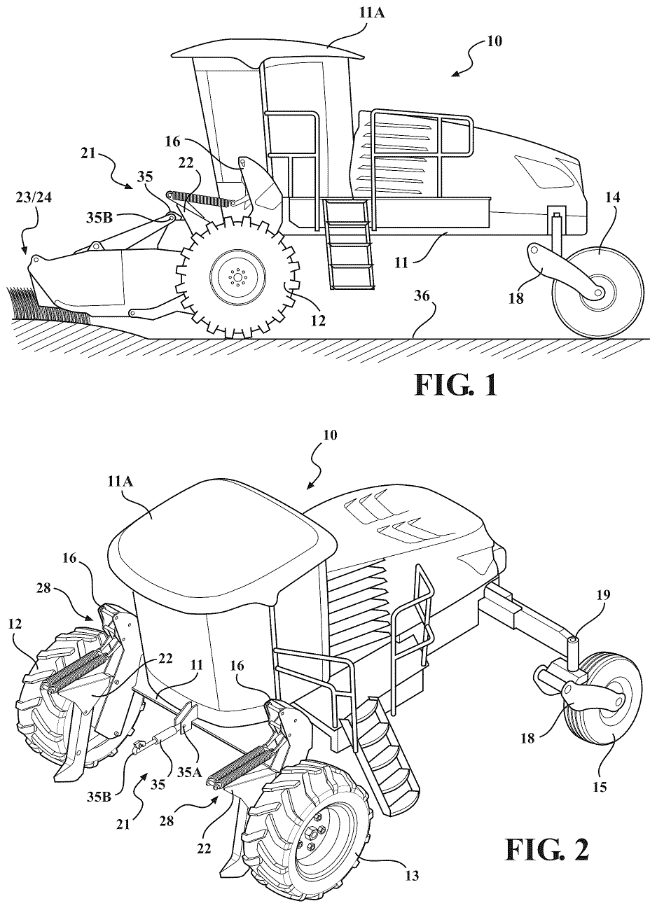

FIG. 1 illustrates an agricultural vehicle configured as a windrower or swather 10, which is provided with a dynamic float control system as described herein that provides dynamic float control that is readily configured for field operations and dynamically adjusts in response to dynamically changing field conditions such as variations in ground contours and undulations, including ground depressions, holes and valleys.

As will be described herein, the structural components of the windrower 10 are controlled by a windrower operating system that operates these structural components typically under the control of or through system inputs from a windrower operator driving the windrower 10. The windrower operating system includes the inventive dynamic float control system described below, wherein the windrower operating system and its dynamic float control system are computer-based systems that comprises processes or routines performed by a system controller such as a CPU in reliance upon data streams input from various system sensors. The windrower operating system and its dynamic float control system may comprise a computing device located on the windrower 10 or remote therefrom, which includes the CPU or processor and other computer-based devices operating a control program and configured to receive inputs, process and store data, and generate outputs. The inputs may comprise sensor data and the outputs may comprise control signals that operate various windrower components and structures. A detailed discussion of the computing environment is not required for an understanding of the present invention.

As to the windrower structures and components, as seen in FIGS. 1 and 2, the windrower 10 includes a frame 11 which is carried on a first pair of driven ground wheels 12 and 13 and on a second pair of non-driven castor wheels 14 and 15. The driven wheels 12 and 13 are mounted on suitable frame supports or wheel legs 16 which support the ground wheels on the frame 11. The castor wheels 14 and 15 are mounted on conventional castors 18 which swivel about a castor pin 19. The castor wheels 14 and 15 are non-driven and can pivot around the castor pin 19 so that the castor wheels 14 and 15 follow the movement of the vehicle as controlled by the driven wheels 12 and 13. The operator's seat may face forwardly in the castor wheel direction such as for transport and rearwardly in the header direction for field operations, wherein the header 23 is driven through the field for cutting of ground cover in typical windrower cutter operations. The windrower operating system may include cab controls that may comprise visual displays for displaying and viewing system settings and performance parameters and may include manual input devices such as joysticks, buttons, knobs and the like.

The frame 11 of the windrower 10 has a header support assembly 21 for removably supporting the header 23 on the windrower 10 wherein the header support assembly 21 provides resilient spring-biased support to the header 23 such that the header 23 is able to float vertically during cutting operations. In particular, the header 23 may be set at a desired cutter height relative to the ground elevation but is still able to float upwardly and downwardly relative to the cutter height to a limited extent, i.e., the header 23 is able to float vertically during cutter operations.

The header support assembly 21 comprises one or more float or lift linkages 22 supported on the wheel frame supports 16 in sidewardly spaced relation, wherein the left and right float linkages 22 are configured for removably engaging with and carrying the header 23. These float linkages 22 have been provided for mounting of diverse types of known headers such as disc type cutters or sickle knife cutters. For purposes of this discussion, the header 23 may be a conventional header 24 such as that shown in FIG. 1. As described further herein, the inventive float control system for the windrower 10 is particularly effective when controlling the float for a header configured as a flex draper 25 such as that shown in FIGS. 5 and 6. While the inventive float control system allows use of a flex draper 25 on the windrower 10, the inventive float control system described herein may also be used with another type of header such as a rotary header 24 if desired, although this would not gain the significant advantages of using the flex draper 25.

The provision of a flex draper 25 is a significant improvement on windrowers. Despite the use of a flex draper type header on a combine harvester in harvesting operations, combines and windrowers are distinctly different types of agricultural vehicles. The use of the flex draper 25 on a windrower 10 has not previously been possible since the function of a flex and float system for flex drapers 25 requires accurate readjustment of the float setting with each change in lift height of the flex draper 25 as discussed below, which therefore differs from conventional windrower configurations having known headers 23. The need for accurate readjustment of flex drapers 25 has impeded and essentially prevented the use of flex drapers 25 on a windrower 10. To accommodate the flex draper 25 on the improved windrower 10, the windrower operating system of the windrower 10 of the present invention preferably includes an inventive, dynamic float control system, which dynamically adjusts during field operations and height changes to provide optimal float for the flex draper 25 as will be described in further detail below.

In more detail as to the known configuration of FIG. 1, the header 23 is preferably carried on the windrower 10 preferably by two float linkages 22 to support left and right sides of the header 23. The float control system described herein, however, may be defined as controlling at least one float linkage 22. The float linkages 22 are generally operable by an operator in the windrower cab 11A to adjust the lift of the header 23 or in other words, to raise and lower the header 23 on the windrower 10 between different working heights. The working heights include a lowered position for working field vegetation as seen in FIG. 1, and a raised position cleared from the ground for transporting the header 23 over the ground. The float linkages 22 also allow for adjustment of the tilt of the header 23.

Still further, the float linkages 22 are each configured as a four-bar linkage with a respective float system 28 that counteracts much of the header weight and can achieve ground pressure or force in the order of 10% of the header mass or weight (or less if desired) while still having acceptable ground following capabilities. However, the current float geometry of a windrower 10 results in a decay of float force with each change in height of the header 23 since the center of gravity of the header 23 and the virtual center of rotation of each float linkage 22 change with height changes as will discussed further hereinafter.

Referring more particularly to the float linkage 22 shown in FIGS. 2-5, the frame supports 16 are vertically elongate and robust, and include wheel mounts 29 that support the hubs of the drive wheels 12 and 13 of the vehicle frame 11. The frame supports 16 are accessible from the exterior rear of the windrower 10 proximate the wheels 12 and 13 respectively, so as to mount a respective float linkage 22 thereon with the float linkages 22 being disposed in laterally or sidewardly spaced relation. The frame supports 16 and other parts of the frame 11 serve as mounting points for several components of the float linkages 22 as well as the float system 28 to thereby support the header 23 on the windrower 10. Further, the frame support 16 defines one leg of the four-bar linkage of the float linkage 22. The float linkages 22 may support a rotary header 24 as seen in FIG. 1 and also may mechanically support a flex draper 25 as shown in FIG. 5.

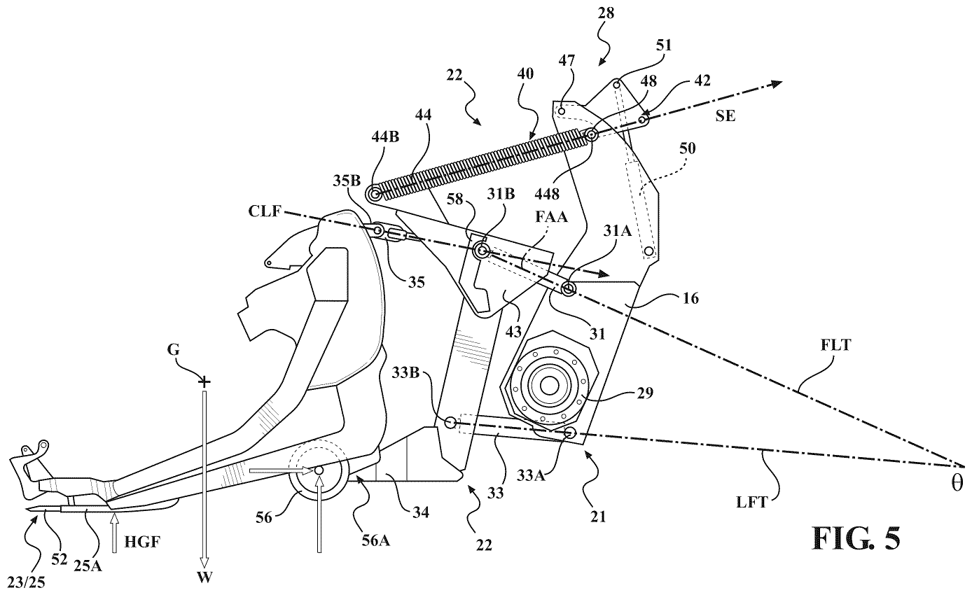

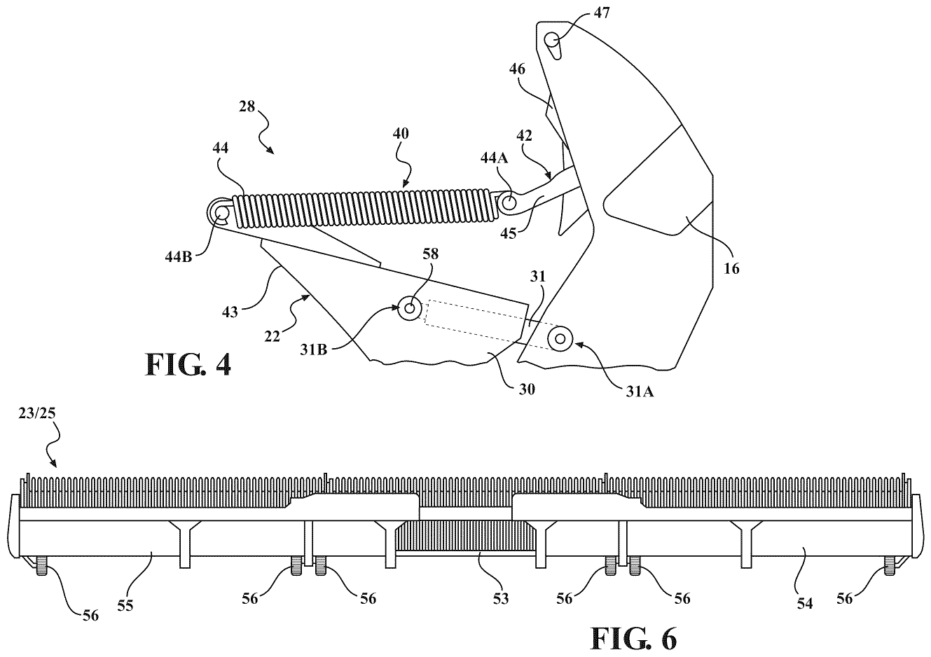

Each float linkage 22 also includes a vertically elongate lift leg assembly 30, which is spaced rearwardly from the frame support 16 and is connected near its upper end to the frame support 16 by a horizontally-extending float arm or float link 31 which extends into the lift leg end as shown in phantom outline in FIG. 4. The lift leg assembly 30 may also be more simply identified as a “lift leg” or “lift arm” 30. The opposite inboard and outboard pivot ends 31A and 31B of the float arm 31 are pivotally connected to the frame support 16 and lift leg 30 respectively so that the lift leg assembly 30 is movable vertically as the float arm 31 pivots about the inboard pivot end 31A.

The lower end of the lift leg 30 is also pivotally connected to the frame support 16 by a lift cylinder or actuator 33, wherein the lift cylinder 33 has opposite inboard and outboard ends 33A and 33B pivotally connected to the frame support 16 and lower end of the lift leg assembly 30. The lift cylinder or actuator 33 preferably is configured as a hydraulic cylinder or other type of extendable actuator such as a linear actuator that shortens and lengthens the length of the lift cylinder 33 to displace and vertically lift the lower end of the lift leg 30. As such, referencing the lift cylinder as a lift actuator would broadly encompass these different actuator types.

Collectively, the lift leg 30, frame support 16, float arm 31 and lift cylinder 33 are pivotally connected together to effectively define an adjustable four-bar linkage, wherein extension or lengthening of the lift cylinder 33 raises or lifts the lift leg assembly 30 while retraction or shortening of the lift cylinder 33 lowers the lift leg assembly 30. The four-bar linkage is adjustable in that adjusting the length of the lift cylinder or actuator 33 adjusts the geometry of the four-bar linkage and adjusts the lift of the header 23. Once the four-bar linkage geometry is adjusted to a preferred geometry, the four-bar linkage can also articulate during field operations wherein each lift leg 30 can float vertically relative to its'respective frame support 16 fixed on the windrower 10. Further the four-bar linkages defined by the plurality of float linkages 22 can move independently of each other to an extent.

To support the header 23 on the float linkages 22, the lower ends of the lift legs 30 include forwardly-projecting header supports 34 (see FIG. 5) commonly referenced as “boots” that engage with the header 23 to removably mount the header 23 on the windrower 10. The header 23, whether a conventional header 24 (FIG. 1) or flex draper 25 (FIG. 5), is removably mounted to the boots 34, and the header height thereof is adjusted by articulation of each four-bar float linkage 22 through operation of the respective lift cylinder 33. Preferably, one float linkage 22 is provided on each of the left and right sides of the header 23 to independently support the left and right end sections of the header 23 as described further below.

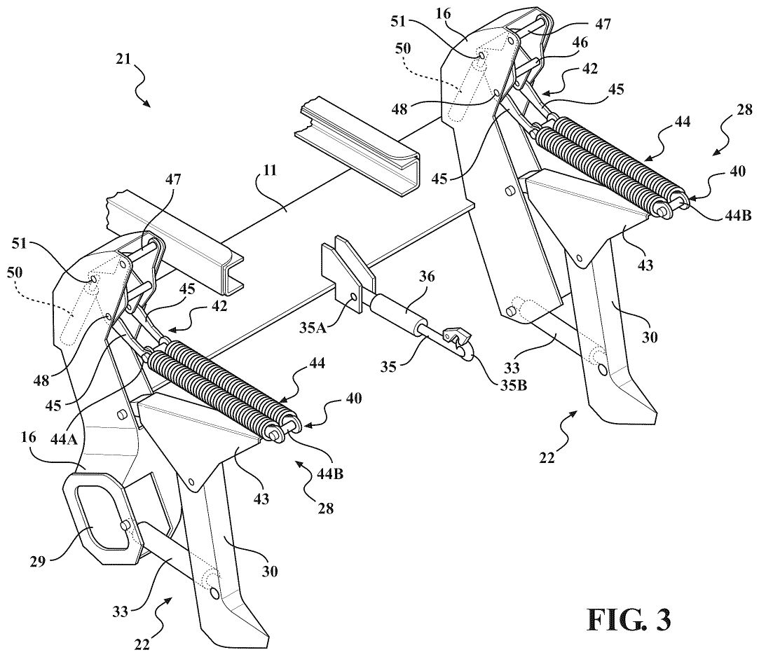

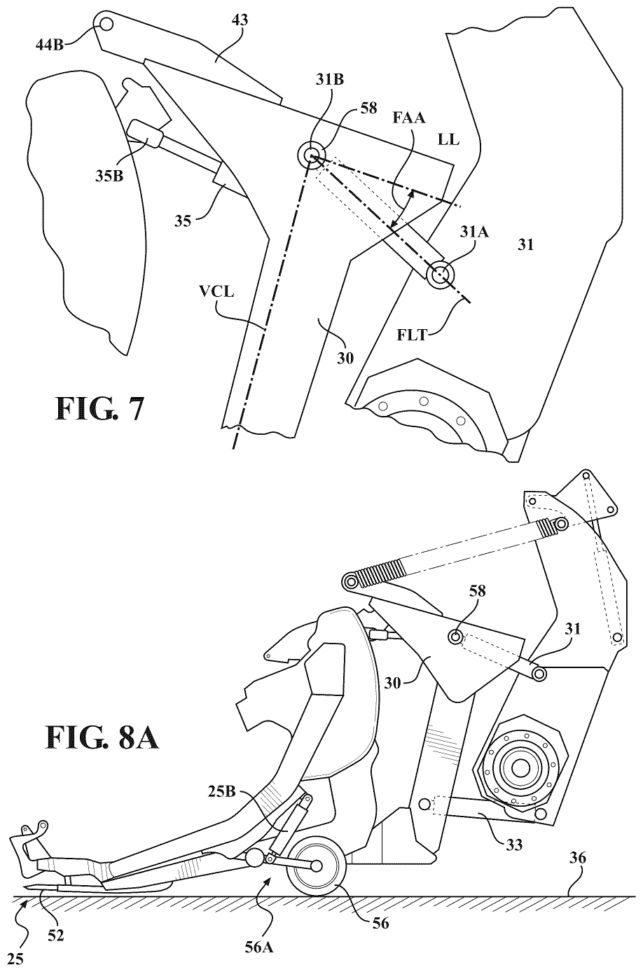

As best seen in FIGS. 3 and 5, the center link or tilt link 35 is also provided to control the tilt of the header 23, wherein the center link 35 includes a hydraulic tilt cylinder 36 (FIGS. 3 and 7) or other extensible actuator to vary and adjust the tilt of the header 23 relative to the float linkages 22 and windrower 10. The term tilt actuator may encompass a hydraulic cylinder and as well as other types of actuators suitable for adjusting the header tilt. More particularly, the center link 35 includes an inboard end 35A pivotally connected to the windrower frame 11 (FIG. 3) and an outboard end 35B removably attached to the upper section of the header 23 above the boots 34 (FIG. 5). The center link 35 can thereby extend or retract to change the tilt angle or tilt of the header 23 relative to the windrower 10 and the ground 36 (see FIG. 1).

For reasons discussed further herein, the tilt cylinder or actuator 36 of the center link 35 and the lift cylinder or actuator 33 preferably include suitable sensors to indicate the operating state thereof such as the overall length or translation thereof during operation to determine the respective tilt setting and lift setting thereof. The tilt setting and lift setting may be defined in terms of the percentage of the total operating range of the respective tilt actuator 36 or lift actuator 33. The dynamic float control system will monitor these operating states during field operations as will be described further below.

Referring in more detail as to FIG. 5, the float linkages 22 and their respective float systems 28 define the supporting geometry for the header 23 and in particular, for the flex draper 25 shown in FIG. 5. As such, the various forces acting through this system may vary as the float linkages 22 and float system 28 are adjusted and controlled. As mentioned above, the use of a flex draper 25 on the windrower 10 has not previously been suitable until the current development of the dynamic float control system of the present invention.

Turning next to the specific features of the flex draper 25, each particular flex draper 25 may have a different weight, which may vary depending upon the size of the flex draper 25 or any components added or removed thereto. Generally, the weight W of the flex draper 25 is shown acting through the center of gravity G. The variables of lift and tilt and the height of the flex draper 25 relative to the ground elevation 36 can vary the location of the center of gravity G of the flex draper 25 relative to the boots 34 on any particular windrower configuration. Depending upon the settings for these variables, the header ground force HGF at the lead edge of the flex draper 25 can vary. In one configuration, the flex draper 25 may be supported by ground-following support structures 25A such as skid plates or shoes, cutterbar polys or wearplates, or other physical structures. As noted, the flex draper 25 is carried on the boots 34 such that the weight W defines components of boot forces By and Bx acting on the boots 34. A center link force CLF is also generated on the center link 35, which acts along the length axis of the center link 35 as shown in FIG. 5. Further, a float spring force also acts along the length axis of the float system 28, which is identified as the spring extension line SE.

As previously noted, the geometry of the four-bar linkage is adjustable by the operator and the four-bar linkage articulates during field operations. In the illustrated configuration of FIG. 5, the float arm 31 and lift cylinder 33 define respective axes FLT and LFT which extend toward the front of the windrower 10 and intersect at a center of rotation O of the four-bar linkage, which may also be referenced as the virtual center of rotation O. As the geometry of the four-bar linkage is adjusted or articulated by the lift cylinder 33, the center of rotation O will also move forwardly or rearwardly due to angular changes in the orientation of the lift cylinder 33 and float arm 31. These structural characteristics of the flex draper 25 may change depending upon how the flex draper 25 is configured by the operator using the windrower operating system, but at the same time, the dynamic float control system is able to optimize header performance despite these changes.

In more detail as to the float system 28, the windrower 10 uses spring tensioners 40 to generate respective float forces that counterbalance most of the header or flex draper weight W and to thereby adjust ground forces imparted on the ground surface by the flex draper 25. The spring tensioners 40 maintain the necessary conditions for the flex draper 25 to float effectively during agricultural operations. Each spring tensioner 40 is variable to adjust the biasing force or float force generated thereby which float force acts along spring extension line SE. In the improved windrower 10 as shown in FIGS. 3-5, the float force is preloaded to define a preload float force that can be set and also be dynamically changed through articulation of a float link assembly 42 that connects between the frame support 16 and the lift leg assembly 30.

In particular, the upper end of the lift leg assembly 30 includes a float bracket 43 thereon, which projects outwardly away from the windrower 10 and supports an outboard end of a spring assembly 44 thereon. Preferably, each spring assembly 44 comprises a plurality of parallel coil springs held in tension to counteract at least part of the flex draper weight W, which acts to pull the coil springs in tension. As seen in FIGS. 3 and 4, the outboard end 44B of the spring assembly 44 pivotally attaches to the outer end of the float bracket 43 which is attached to the lift leg 30 to thereby counteract the header weight W acting on the lift leg 30 through the boots 34.

The float link assembly 42 comprises intermediate links 45 and a pivotable float link 46, which is pivotally connected to the frame support 16 as best seen in FIG. 5. The inboard end 44A of each spring assembly 44 attaches to one or more of the intermediate links 45 that in turn connect to the respective float link 46 of each float assembly 22. The float link 46 rotates on the frame support 16 on an axis 47 spaced from the connection points 48 for the intermediate links 45, wherein the rotated position of the float link 46 thereby sets the amount of extension of the spring assembly 44 and sets the tension preload or float force generated thereby, The float force or float preload is adjustable to increase or decrease as the float link 46 rotates in opposite directions about axis 47. Each float link 46 is driven or controlled by a float cylinder 50 or other type of actuator connected at pivot axis 51 to effect controlled rotation of the float link 46 and thereby extend the spring assembly 44 and set the spring tension generated by the spring assembly 44 connected thereto. This spring tension counteracts most of the weight W of the header 23 to reduce the header ground force and holds the flex draper 25 at a float position defined by the float preload. Further, the spring assemblies 44 are held in tension but can extend and retract under the action of header loads generated during field operations so that the flex draper 25 can float upwardly from the float position when subjected to a lifting force that is a fraction of the total header weight W. Further, the flex draper 25 is configured to follow ground undulations such that the flex draper 25 can float upwardly and downwardly from the initial float position in response to ground affects.

In the absence of other changes to the tilt cylinders 36 and the lift cylinders 33, operating the float adjustment cylinders 50 to thereby extend these cylinders 50 serves to pivot the float plate 46, extend the spring tensioners 44, and thereby increase the tension in the spring tensioners 44 and thereby increases the float forces that act to reduce the header's ground force. The percentage of extension of the float adjustment cylinders 50 defines the float setting FS thereof. The float setting FS can increase or decrease to increase or decrease the float force, such that the float adjustment cylinders 50 are used to set the optimal float for the flex header 25.

In more detail as to the float setting FS, the float system 28 is configured to carry most of the header weight W, while allowing upward and downward floating of the flex draper 25 relative to the windrower 10 and ground 36 in response to upward and downward forces imparted on the flex draper 25 during typical field operations. For example, the flex draper 25 may rise and fall when following ground contours, undulations and depressions such as bumps and holes in the ground contour.

Preferably, the tensioner spring assemblies 44 are set at a float setting FS to define a preloaded float force that carries most of the header weight W while also allowing the upward lifting and downward dropping of the flex draper 25 and a cutterbar 52 carried on the leading edge thereof (see FIG. 5). Each float cylinder 50 is controlled and actuated by the float control system described herein to adjust the spring extension generated by the spring assembly 44 and thereby adjust the spring tension. The float setting is defined by the spring tension and functions to govern the portion of the total header weight W countered by the spring or float forces. As such, most of the header weight W is carried by the float system 28 and the flex draper 25 is able to float or displace upwardly in response to ground effects imparting an upward lift force that is only a small portion of the total header weight, wherein the extended spring assemblies 44 may contract in such a condition. As the spring assemblies 44 contract, the float force may decrease so that less header weight W is counteracted by the spring assemblies 44. While this temporarily tends to increase the effective ground force of the flex draper 25, the increase in effective header weight tends to return the flex draper 25 back to the initial float position.

Further, where the ground contour or elevation 36 drops, the flex draper 25 may fall downwardly relative to the ground elevation 36, for example, into a depression or hole, wherein the downward header movement is counteracted by tension forces generated by the spring assemblies 44. When the flex draper 25 is positioned closer to the ground such as in FIG. 5, the downward movement tends to increase the effective weight of the flex draper 25 and the ground force thereof to maintain the flex draper 25 in ground contact.

To provide improved performance for the flex draper 25, the improved windrower 10 and windrower operating system comprises a dynamic float control system that configures the windrower 10 to mount and operate the flex draper header 25 thereon. The flex draper 25 is of a type that has been used on combines but is now modified and configured for use on a windrower 10 through the improved and inventive float control system. The flex draper 25 of FIG. 6 comprises header segments defined by a center segment 53 and left and right wing segments 54 and 55, wherein these interconnected segments 53, 54 and 55 can articulate and follow ground contours. The flex draper 25 preferably includes height adjustable, contour-following or ground-following contour wheels or support wheels 56 that can be adjusted in response to changes in ground contour; however the float control system will work when operating on the ground-following support structures 25A, wherein a support structure 25A may be a skid shoe or a cutterbar poly or shoe and the flex draper 25 may include a plurality of the support structures 25A comprised of one or the other or a combination of both. The float control system works in a similar fashion when cutting on the ground but the system is essentially optimized for that position and dynamic control is still applicable.

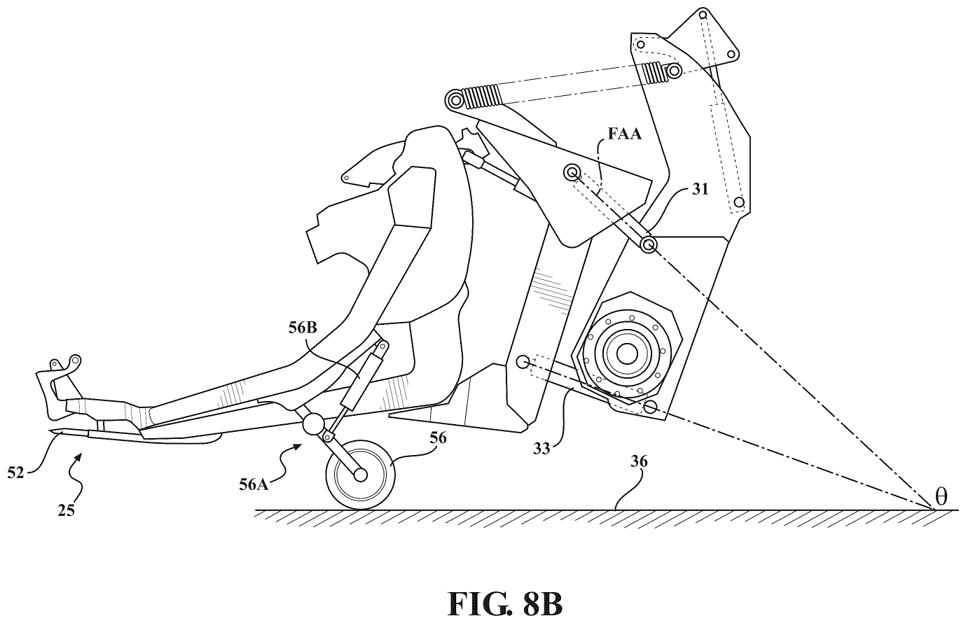

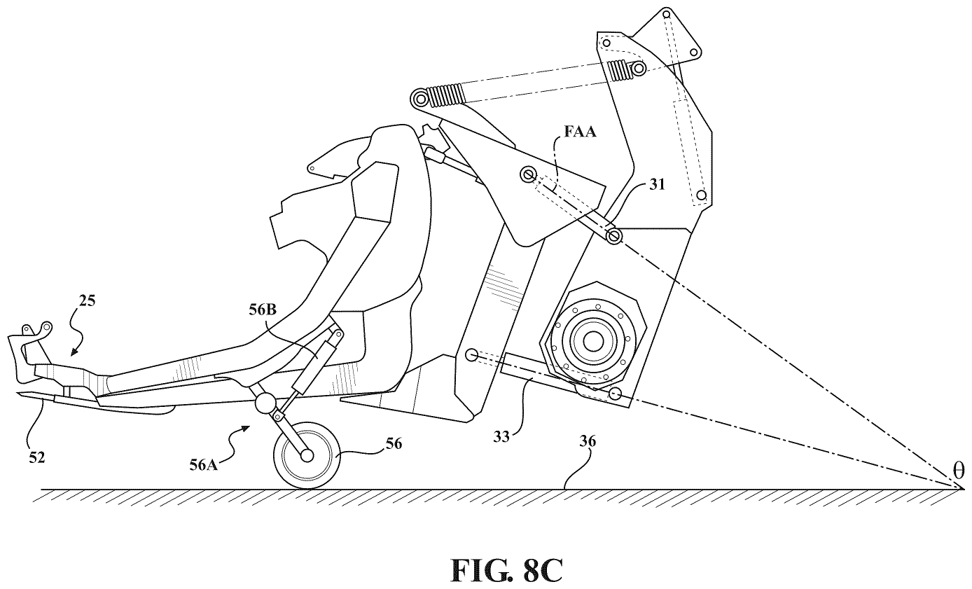

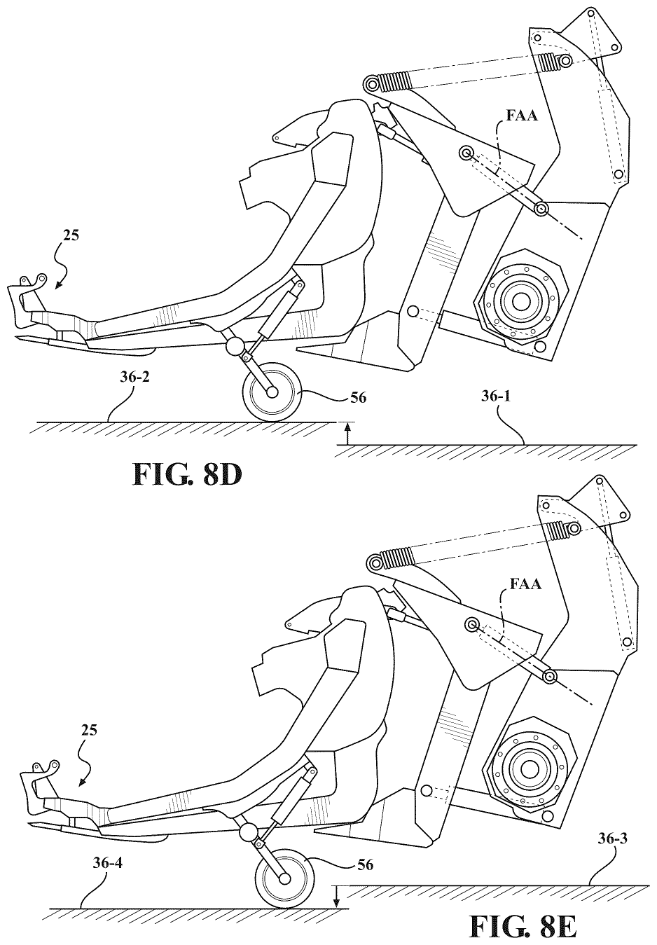

The contour wheels 56 include contour wheel actuators 56A (FIG. 5) that can be set by the operator using other controls of the windrower operating system to raise and set the height of the flex draper 25 relative to the ground 36. The contour wheel actuators 56A may comprise contour wheel cylinders 56B (FIGS. 8A-8C) such as hydraulic cylinders that extend and retract wherein the extent or percentage of extension is reference as the contour wheel cylinder or actuator setting that defines the percentage of total lift that the contour wheels provide. The contour wheels 56 provide substantial lift to the flex draper 25, wherein the total lift range may reach 18 inches although the invention is not limited to a particular height. The contour wheel cylinder setting might also be referred to as CMax cylinder setting herein. The contour wheel actuators 56A might also take the form of other types of linear and non-linear actuators that raise and lower the contour wheels 56 such that the term contour wheel setting can also reference the percentage of total lift provided by the contour wheels 56.

A preferred form of these contour wheels 56 is currently sold by the applicant for this patent application, namely MacDon Industries Ltd., under their proprietary ContourMax TM brand. The disclosure herein may reference both contour wheels 56 or CM contour wheels 56, with CM referencing the ContourMax system. In comparison to fixed gage wheels that do not provide substantial height adjustment, the inclusion of these contour wheels 56 with a flex draper design distributes the header load more evenly across these contour or support wheels 56 to allow for improved weight distribution during operation over ground undulations. This improved load support better distributes header weight W across the center segment 53 and wing segments 54 and 55.

The windrower operator thereby can use ground-following contour wheels 56 as a means to increase and control the height of the flex draper 25 while allowing it to follow the field topography, similar to when it is cutting on the ground. When determining appropriate cut height, an operator determines the length of stubble desired and may adjust the height of the contour wheels 56, which in turn adjusts the height of the cutterbar 52. As the contour wheels 56 raise and lower the flex draper 56, the four-bar linkage of the float linkages 22 articulates and changes in geometry.

To monitor the relative orientation of the four-bar linkage, a float arm to lift leg angle FAA(FIGS. 5 and 7) is measured and monitored using an indicator sensor preferably configured as a potentiometer 58 mounted on each lift leg 30 of each side. One sensor indicator such as the potentiometer 58 may be provided as part of the float control system on each of the left and right lift leg assemblies 30 where the float arm 31 connects to the lift leg 30. The float arm to lift leg angle FAA is also referenced herein as the float arm angle FAA, and is defined by the angle FAA between the float arm line FLT of the float arm 31 and a lift leg reference line LL on the lift leg 30. This lift leg reference line LL is formed at a right angle relative to the vertical center line VCL of the lift leg 30 such that changes in the float arm to lift leg angle FAA indicate changes in orientation of the float arm 31 relative to the lift leg 30. For brevity herein, the float arm to lift leg angle FAA may also be referenced as the float arm angle FAA.

To monitor the float arm to lift leg angle FAA, the potentiometer or other type of indicator sensor 58 generates sensor data indicating the magnitude of the float arm angle FAA, wherein this float arm angle FAA changes during adjustment of the geometry of the four-bar linkage, and changes during movement of the flex draper 25 is it floats vertically when following ground contours. As such, the float arm angle FAA can indicate an initial set point associated with the geometric configuration for the flour bar linkage and can indicate vertical movement of the flex draper 25 upwardly and downwardly as well as the direction of movement up or down, particularly by monitoring angular changes in the float arm angle FAA and the differential rate of such angular changes over time during field operations. The role of such float arm angle FAA will be described further below relative to the inventive float control system.

Referring in more detail as to FIGS. 8A-8E, the float arm to lift leg angle, i.e. the float arm angle FAA provides a valuable monitoring point. In the illustrated embodiment, the total range of the float arm angle FAA starts at about 0° and may increase to about 32°. Referring to the figures, FIG. 8A illustrates the flex draper 25 at a lowered position contacting the ground elevation wherein the contour wheels 56 are not extended and wherein the float arm angle FAA is decreased. The cutterbar 52 is at its lowest position and generally runs along the ground elevation in close proximity therewith.

Referring to FIG. 8B, the contour wheels 56 are extended to raise or lift the flex draper 25 without reliance upon the lift cylinders 33, which thereby raises the cutterbar 52 above the ground elevation 36 and increases the stubble height left after vegetation is cut by the cutterbar 52. As the contour wheels 56 extend and lift, the four-bar linkage articulates by pivoting of the lift cylinder 33 and float arm 31, which increases the float arm angle FAA.

Referring to FIG. 8C, the lift cylinder 33 is extended, which further raises the cutterbar 52 above the ground elevation 36. As a result, the float arm angle FAA decreases as the length of the lift cylinder 33 increases, and vice versa. As the float control system monitors each float arm angle FAA by the respective potentiometer 58 and monitors the operating state of the lift cylinders 33 and/or contour wheels 56, the float arm angle FAA can be used to indicate the operating condition of each of the left and right sides of the flex draper 25 at a particular ground elevation 36 under both stationary and operating conditions.

Further, during field operations, the flex draper 25 is able to float upwardly and downwardly due to the float linkages 22, wherein the float arm angle FAA dynamically changes in response to dynamic changes in ground elevation 36. As seen in FIG. 8D, an increase in ground elevation is illustrated by the first ground elevation 36-1 that then changes into a raised or positive second ground elevation 36-2 that lifts the flex draper 25 and increases the float arm angle FAA.

The elevation increase may be the result of many factors such as undulating ground contours, abrupt bumps and the like and the dynamic increase in float arm angle FAA is usable as an indicator of an elevation increase. Referring to FIG. 8E, when there is a negative ground elevation such as the drop from ground elevation 36-3 to ground elevation 36-4, decreases in ground elevation would decrease the rate of the float arm angle FAA to a negative degree and such a negative decrease is usable as an indicator of a ground elevation drop. A positive increase in ground elevation would result in a positive increase in the rate of the float arm angle FAA, which in turn would indicate the flex draper 25 is lifting. In one example, a negative angle change can indicate the flex draper 25 and contour wheels 56 thereof are dropping into a hole in the field, and a positive angle change can indicate the flex draper 25 and contour wheels are rising out of such hole. The rate of these changes also indicates the abruptness of the elevation increase or decrease.

In a further aspect, the magnitude of the float arm angle FAA can indicate how much of the total range of travel that the flex header 25 can move upwardly or downwardly. As noted, the flex arm angle FAA may have a range of travel of approximately 30°, or from 0°-32°, which are the lower and upper range limits for the exemplary embodiment described herein. This would define the total float range that the flex draper 25 could float, wherein the flex draper 25 preferably is maintained in the middle of this float range, i.e., in the middle of the float. Depending upon the construction of the particular flex header, lower and upper range limits for the float range can vary from this particular example.

Referring to this exemplary embodiment, the four-bar linkage has room for upward travel if the float arm angle FAA is less than the upper travel limit, which in this case is 32°. Conversely, the four-bar linkage has room for downward travel if the float arm angle FAA is greater than the lower travel limit, which in this case is 0°. Accordingly, the float control system can monitor the set operating position or height of the flex header 25 relative to the upper and lower travel limits of the float range. Preferably, the flex draper 25 is operated in the middle of this total float range so that it can float both above and below the operating position as will be described further below.

The improved windrower 10 is configured to preferably include the flex draper 25 for use in typical windrower field operations wherein the improved float control system is provided to adjust the float preload based upon height changes of the flex draper 25 on the windrower 10. for The inventive float control system is able to provide optimal header performance by setting an optimal float setting that is adjusted in response to changes in header height for the flex draper 25.

With the incorporation of this flex draper 25 on a windrower 10 using adjustable contour wheels 56, the optimal float setting for the flex draper 25 is a function of several variables for the flex draper type header, wherein these variables include both the header tilt and the header height, i.e., the height of cutterbar 52 or flex draper 25 off the ground. These variables include both the header tilt and header height, which affect the position of center of gravity (G or CoG) of the flex draper 25, which affects the overall operation of the flex draper 25 and the float preload used thereon.

In this inventive configuration, the header height can be changed by either the windrower lift cylinders 33 that raise and lower the flex draper 25, or by the contour wheel actuators 56 that adjust the cutterbar 52 by adjusting the contour wheel positions, or the combination of both the lift cylinders 33 and contour wheel actuators 56B. Therefore, the optimal float setting on the improved windrower 10 is a function of a combination of multiple variables for the flex draper 25 including the tilt setting of the tilt cylinder 35 that adjusts the tilt of the flex draper 25 relative to the windrower 10 and ground 36, the lift setting for the lift cylinders 33 that adjusts the cutterbar height relative to the windrower 10 and ground 36, and settings of the contour wheel actuators 56B, which also adjust the cutterbar height relative to ground 36 by the contour wheels 56 being in contact therewith. Ultimately, these variable settings affect the overall ideal float of the flex draper 25, which is the percentage of the header weight supported by the float system 26 which in turn reduces the effective weight of the header or flex draper 25 transferred to the ground through the contour wheels 56 or other ground engaging support structures 25A such as skid plates or shoes, or cutterbar polys or wearplates, or a combination of both that may be associated with the header 25 and cutter bar 52 thereof. During the operation of the windrower 10 with the flex draper 25, the float setting may be dynamically changed by the inventive float control system taking into consideration changes in other variables as described above. The inventive float control system thereby automates the adjustment of the float setting FS in dynamic response to changes in these other header settings, which thereby allows for the simplification of the flex draper operation and accommodates rapid changes in cutterbar height in the field with minimal loss of float performance and flex performance.

Each combination of changes to the header tilt, contour wheel height, and header lift, along with other ground profile influences, thereby affects the relative position of the center of gravity G of the flex draper 25 relative to the boots 34, and the virtual center of rotation O (FIG. 4) of the four-bar float linkage, wherein the changes to these variables thereby varies the float support generated on the header by the float system 28. Despite the changes to these variables, the float setting for the float system 28 preferably should stay relatively constant at an ideal or optimal setting to provide consistent performance of the flex draper 25. Any change in any one of those variables, therefore, corresponds to a unique float adjustment cylinder setting for maintaining an optimal float for the flex draper 25.

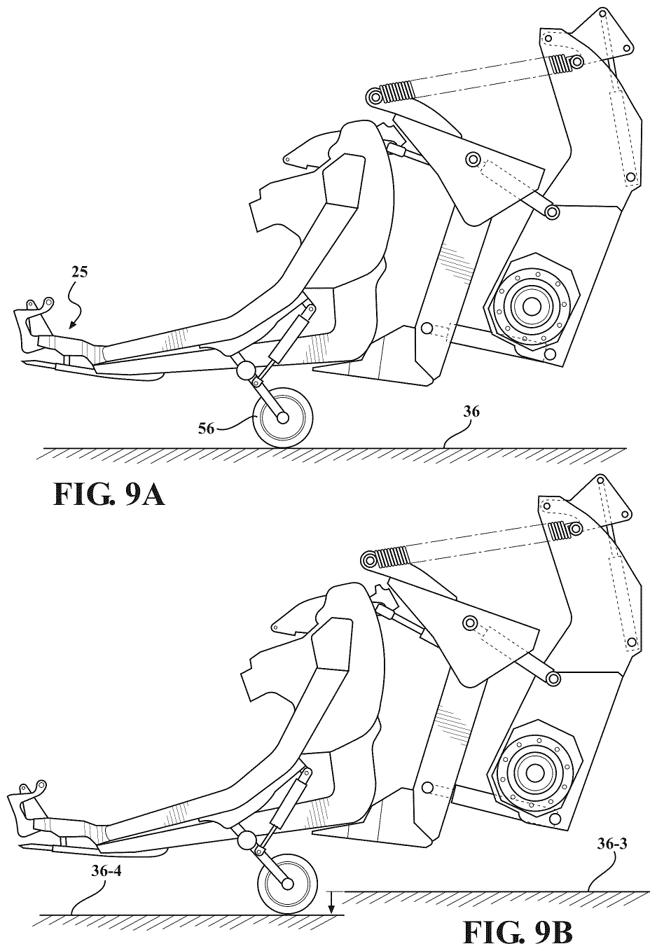

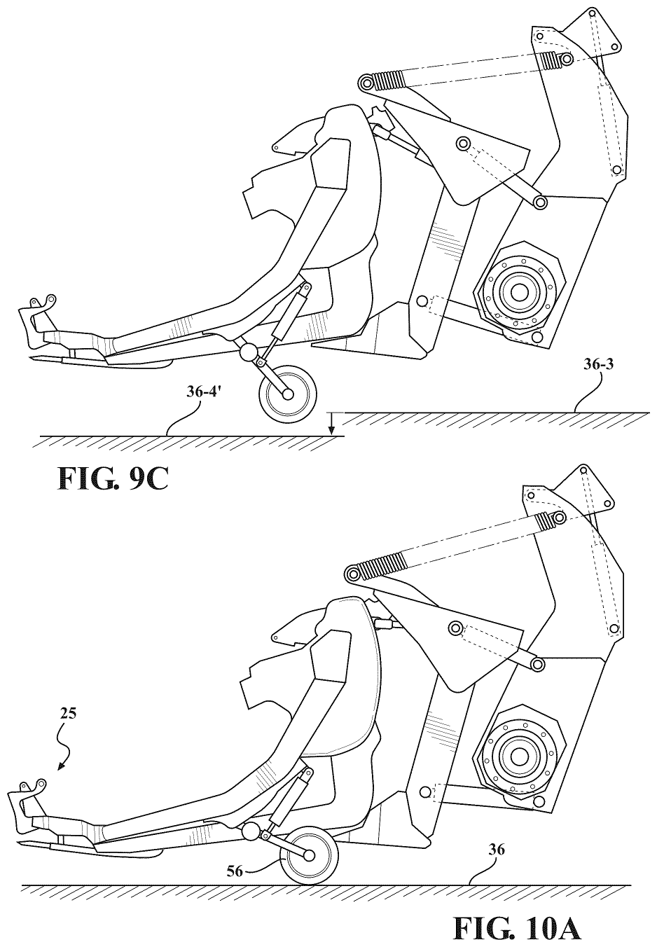

To illustrate the improved performance of the inventive, dynamic float control system versus no dynamic float control, FIGS. 9A-9C illustrate a theoretical system, which does not incorporate dynamic float control. In this theoretical example, the float setting may be set so that the flex header 25 has most of the header weight offset by the resilient float. In FIG. 9A, the contour wheels 56 are extended and remain in contact with the ground elevation 36 with a set ground contact force. In FIG. 9B, the ground elevation 36-3 begins to drop as represented by ground elevations 36-4. As this drop occurs, the spring tensioners 44 carry an increased load and eventually may carry the entire header weight W as seen in FIG. 9C.

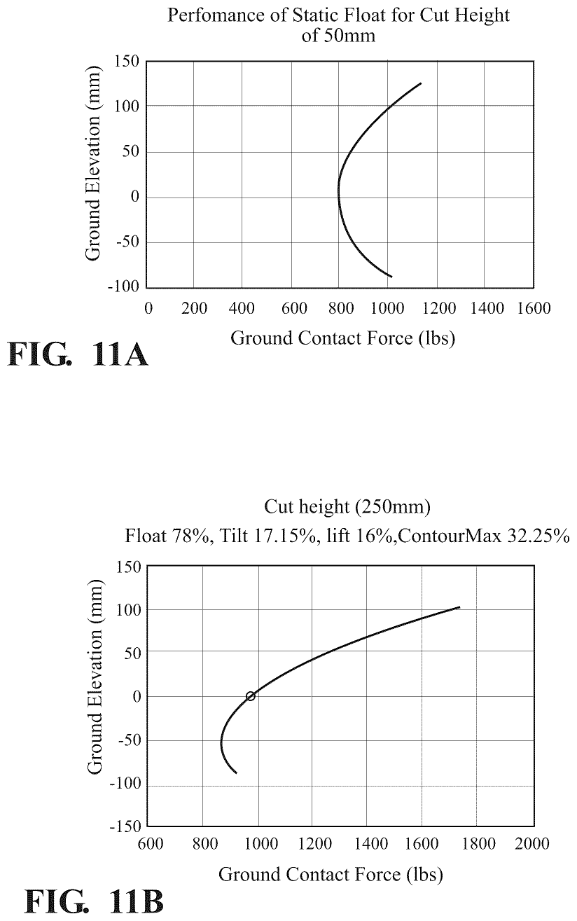

Referring to FIG. 11A, a ground force curve shows the ground elevation relative to ground contact force as a flex draper 25 drops or rises above the zero ground elevation line. As seen, the ground force increases as the flex draper 25 rises and drops due to the reduced spring force during header rise, which imparts greater header weight to the ground, or due to the increased downward header movement as the header 23 drops into a depression. However, in FIG. 9C, if the ground elevation continues to drop to ground elevation 36-4′, the spring extension may max out and hold the flex draper 25 elevated, or in other words, the flex draper 25 may drop too slowly due to the increasing spring force such that the flex draper 25 may lose ground contact and remain suspended above the ground elevation 36-4′, which may then result in excessive stubble height in this depressed area. This problem is more noticeable when the contour wheels 56 are elevated to a significant degree, which alters the geometry of the four-bar linkage, the center of gravity G and virtual center of rotation O in a manner which tends to increase the float force and reduce the ground force.

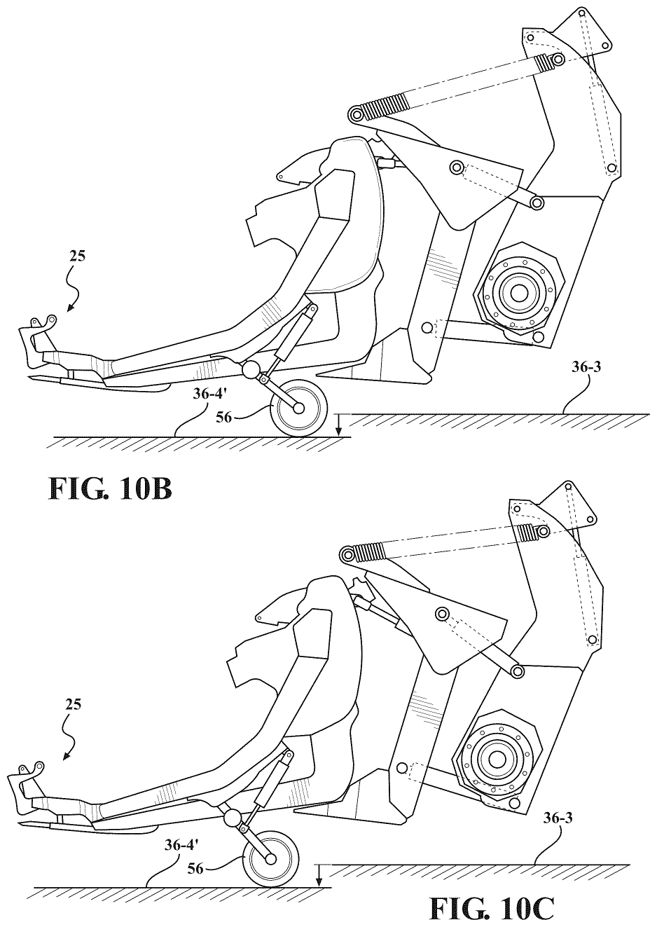

As a solution to this problem, an example of dynamic float control shown in FIGS. 10A-10C according to the present invention. Herein, the float setting FS may be set so that the flex header 25 has most of the header weight offset by the resilient float but the float setting FS then may dynamically adjust during elevation changes. In the illustrated configuration with the contour wheels 56 raised, the ground force tends to get lighter as the flex draper 25 drops. In FIG. 10A, the contour wheels 56 are extended and remain in contact with the ground elevation 36 with a set ground contact force under normal operation. In FIG. 10B, the ground elevation begins to drop as represented by ground elevations 36. As this drop occurs, the spring tensioners 44 carry an increased load but the contour wheels 36 remain in load bearing engagement with the depressed ground elevation 36-4. At the same time, the dynamic float control system is able to detect this elevation drop through the change in the float arm angle FAA, and then dynamically adjusts the float setting to increase the header weight carried to the ground. In FIG. 10C, if the ground elevation continues to drop to ground elevation 36-4′, the flex draper 25 continues to drop. The float control system then reduces the float setting FS automatically and dynamically to reduce the float force and make the flex draper 25 heavier so that it remains in contact with the ground elevation 36-4′, which maintains the preferred stubble height in this depressed area. The float arm angle FAA also may indicate that the ground elevation is increasing, which would then be used to increase the float force and make the flex draper 25 lighter as it comes out of the depression.

Referring to FIG. 11B, an illustrative graph is shown for set conditions of the flex draper 25 under dynamic control, wherein the graph shows a ground force curve showing the ground elevation relative to ground contact force as the flex draper 25 drops or rises above the zero ground elevation line. In this configuration, the variables are set with the float setting FS for the float cylinder 51 at 78% of its full extension, the center link 35 at 17.15% of extension, the lift cylinder 31 at 16% of extension, and the ContourMax contour wheels 56 at 32.25% of their total height range. Typically, the total height range for the contour wheels 56 is about 18 inches although this is variable wherein the contour wheel setting would be at 100% to achieve this total height range.

According to these variables, the ground force curve is shown wherein the ground contact force initially decreases until a defined depth, after which the dynamic float control system adjusts the optimal float setting FS to increase the ground contact force. This increase thereby causes the flex header 25 to preferably drop faster into the ground depression or hole so as to avoid separation therefrom as the flex draper 25 and contour wheels 56 thereof enter the ground depression. Conversely, if the flex draper 25 rises, the float force from the spring assembly 44 decreases so that more header weight is transferred to the ground force, which is counteracted by reducing the float force to optimize the float force while maintaining ground contact between the contour wheels 56 and ground elevation 36.

Referring more particularly to the dynamic float control system, the float control system relies upon one or more optimal float setting curves that are used to define an optimal float setting FS for the float cylinder 50. Each optimal or ideal float setting curve is based upon system characteristics including the contour wheel cylinder setting that defines the contour wheel height and the calibrated weight for each of the left and right sides of the flex draper 25. The term float setting curve described herein may refer to tables, graphs, algorithms and other numerical calculation schemes to calculate the optimal or ideal float setting curve for a particular operating condition of the flex header 25. It will be understood that other uses of the term “curves” described herein may also refer to tables, graphs, algorithms and other numerical calculation schemes.

Preferably, the float control system generates or stores an optimal or ideal float setting curve for each incremental header weight across a range of header weights. Once a header weight is determined, an optimal or ideal float setting curve may be identified for that header weight and used during the dynamic float control process. The selected ideal float setting curve would preferably define the preferred float setting FS for the float adjustment cylinder 50 as a percentage that corresponds to that header weight while also taking into account the contour wheel setting as a percentage. Essentially, the ideal float setting would depend upon the header weight and counterbalance the majority of that header weight to maintain the flex draper 25 in the middle region of the total float range. Since each header weight would require a different float setting, the optimal float setting curves may vary across the range of potential header weights, and preferably, the weight range would encompass a plurality of incremental weights with an optimal floating setting curve for each weight.

In accord with the disclosure hereof, the optimal float setting curve would determine an optimal or ideal float setting IFS and that ideal float setting IFS as calculated would be used to set the actual float setting FS that is controlled by the float cylinder 50. The actual float setting may be dynamically adjusted during field operations based upon the ideal float setting and changes in ground conditions, with the float control system returning to the ideal float setting when the ground conditions stabilize.

For example, an increase in the actual float setting FS would increase the percentage of full extension of the float cylinder or actuator 50 that would increase the float force applied through the spring assemblies 44. The ideal or optimal float setting IFS in effect defines a float preload acting on the flex draper 25 when ground conditions are stable and adjustment of the float setting is dynamically governed by changes in ground conditions to generate the actual float setting FS applied to the spring assemblies 44 as the flex draper 25 drops and climbs. Preferably, the ideal float setting IFS may be set based upon header characteristics such as header weight and the contour wheel settings. Further, the actual float setting FS may be adjusted to accommodate field conditions as described above and as described in more detail below relative to the dynamic float control system.

Generally, the ideal float setting curves are provided for a range of header weights and an ideal float setting curve is implemented for both the right and left headers sides, which may have different weights. For the range of header weights, the higher range of header weights have higher ideal float settings IFS and the lower range of header weights have lower ideal float settings FS. Preferably, the header weight is calibrated as part of the dynamic float control system as described below so that a particular float setting curve is implemented for each of the right and left sides. These left and right side float setting curves may be the same or different.

As noted, the contour wheel setting, particularly when raised, affects the ground force of the flex draper 25. The ideal float setting curves compensate for this factor. In this regard, the float setting curves essentially define a base float setting for each of a plurality of potential header weights in a header weight range, wherein the base float setting may increase as the weight increases. For example, the weight range of the header side might span 3000-4500 pounds with progressively increasing float settings FS defined in terms of a percentage.

As noted, the CMax or contour wheel setting in percent also affects the float setting and each float setting curve may include a contour wheel adjustment added to the base float setting depending upon the contour wheel setting in percent. The contour wheel adjustment may vary for each float curve corresponding to the incremental weights of a weight range. Generally, the contour wheel adjustment adjusts the base float setting to offset changes in ground force resulting from raising of the contour wheels 56, which affects the location of the center of rotation O of the four-bar linkage and the position of the center of gravity G relative to the boots 34 of the flex draper 25. Therefore, the preload of the float setting FS will progressively increase as the header weight increases and will be set based upon the header weight and the contour wheel setting. As a result, the base float setting FS is also increasing based upon increases in the contour wheel setting for that particular header weight such as by using a mathematical algorithm for the optimal float setting curve. Once the ideal float setting is determined, the float cylinder or actuator 50 is adjusted to this float setting, which preferably is defined as a percentage of the full extension of the float cylinder 50.

As noted, the ideal float setting preferably tracks the float setting FS and adjusts the float setting FS based upon increases and decreases therein. For example, an increase in CMax contour wheel setting, which is the percentage of the total range of lift provided thereby, increases the float setting FS when following the optimal float setting curves. Preferably, the float control system will select an optimal float setting curve for each side by the system using RH and LH calibrated weights.

In more detail, increasing the contour wheel lift setting changes the virtual center of rotation O (FIG. 5) as the geometry of the four-bar linkage changes with the contour wheel lift. As the contour wheels 56 lift the flex draper 25, the virtual center of rotation O shifts closer to the rear of the flex draper 56 (see FIG. 8B), which generates less moment arm and more weight on the ground. As this change occurs and is monitoring by the float control system, the float setting FS would be recalculated and increased to counter the increase in ground force.

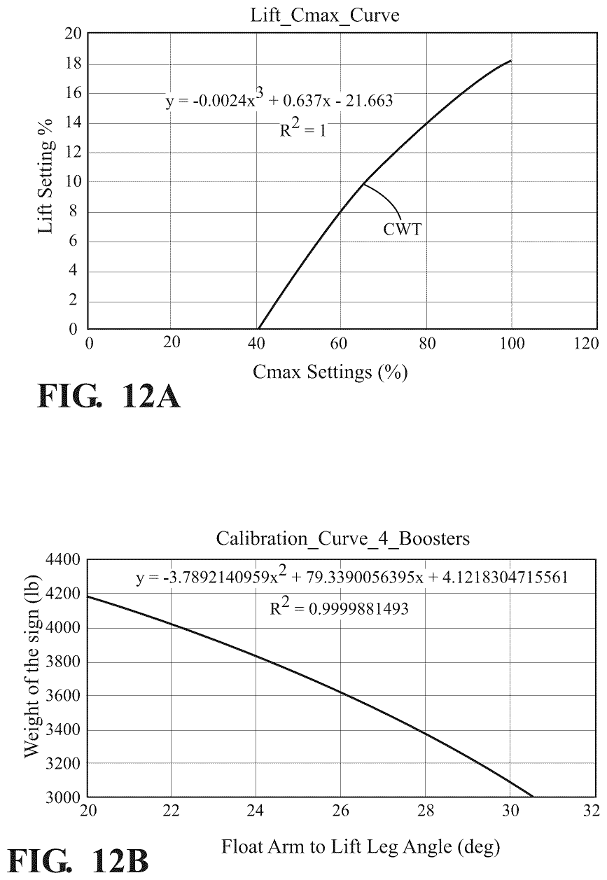

As an additional adjustment, it has been found that there is a contour wheel threshold CWT (see FIG. 12A), above which, the CMax contour wheel setting moves the virtual center O rearwardly and thereby increases the ground force to a degree that the float setting FS moves too far away from the middle of the float setting range. As noted, it is preferred that the flex draper 25 operate with the float setting FS maintained in about the middle of the float range. In the illustrated embodiment, the contour wheel threshold is about 40% of extension and below this contour wheel threshold, the float setting FS typically remains proximate the middle of the float. Above this contour wheel threshold CWT, the float setting FS would move too far from the middle of the preferred float, which is not preferred. In response thereto, above the contour wheel threshold CWT, the float control system may increase the lift by the lift cylinder 33 and adjust the four-bar linkage geometry, which moves the virtual center O forwardly as generally seen in FIG. 8C, which improves the weight distribution on the ground.

Referring more particularly to FIG. 12A, this figure illustrates a lift-contour wheel curve referenced herein as the Lift_Cmax_Curve. This curve plots the Cmax or contour wheel setting versus the lift setting. The contour wheel setting is defined in terms of the percent of the total range of lift provided by the contour wheels 56, wherein this total range may be monitored according to the total stroke of the contour wheel actuator 56B and the percent of such stroke that the contour wheel actuator 56B has extended. Similarly, the lift setting is defined in terms of the percent of the total range of lift by the lift cylinder 33, wherein the total range may be monitored according to the total stroke of the lift cylinder 33 and the percentage of such stroke that the lift cylinder 33 has been extended. Sensors are provided for each of the contour wheel actuator 56B and lift cylinder or actuator 33 to monitor the stroke or extension percentage or other operating state thereof.

The contour wheel threshold CWT is shown on the X-axis, which in this particular embodiment is 40%. Below the contour wheel threshold CWT, the preferred lift setting may be maintained at 0% with the cutterbar height being governed by the contour wheels 56. Above the contour wheel threshold CWT, the Cmax or contour wheel setting is plotted or calculated against the lift setting wherein an adjusted lift setting is determined. For example, if the Cmax setting is at 60%, the lift setting would be adjusted to 8% by the lift cylinder 33 to avoid exceeding the middle of the float by a significant amount. As a result, the dynamic float control system is able to take into account the lift setting relative to the contour wheel setting, particularly as such changes are made by an operator. If the operator adjust the contour wheel setting before or during field operations, the dynamic float control system can detect such changes and adjust the tile setting in response thereto. Above the CWT, the float control system could make automatic adjustment in dynamic response to the operator changes. Below the CWT, the float control system would not change the lift cylinder setting but may still be adjusting the float cylinder setting dynamically.

Next, the tilt setting is also adjustable by the operator although this setting typically has a minimal impact. As disclosed above, the tile setting is defined by the percent of extension of a hydraulic cylinder or other actuator of the center link 35 cylinder that may also be set by the operator. Typically, the tilt setting does not affect the float setting FS to a significant degree unless the flex draper 25 is close to the ground. Therefore, if the Cmax or contour wheel setting is less than 10%, then the ideal float setting FS may be adjusted by a tilt adjustment thereto to compensate for the tilt and ensure that the cutterbar 52 does not have excessive ground contact.

Turning to the float arm angle FAA described above, this float arm angle FAA has an initial value that is determined by the geometry of the four-bar linkage and the setting of the other variables such as lift, tilt and float setting FS, which govern the initial position of the flex draper 25 relative to the ground elevation 36. As described further herein, the float arm to lift leg angle FAA also dynamically changes in response to floating of the flex draper 25 during ground following field operations. The float arm to lift leg angle FAA may both increase and decrease as the flex draper 25 floats vertically above and below its initial float position in the middle of the float range. The float setting FS defines the float force that tends to bias the float arm to lift leg angle FAA back upwardly to the initial float position, wherein the header weight tends to return the flex draper 25 downwardly to the initial float position.

The float arm to lift leg angle FAA is monitored by the float control system, which also monitors changes in float arm to lift leg angle FAA over time, wherein these time-based, dynamic changes are used to calculate a Differential FAA. The Differential FAA indicates the amount of movement of the flex draper 25 upwardly (positive Differential FAA) and downwardly (negative Differential FAA). For example, the float control system may detect data readings for the float arm angle FAA over time, which results in incremental readings that may change or differ over time segments, i.e. there would be a differential in float arm angle FAA between one reading and the next successive reading(s).

In a typical field operation, the negative Differential FAA would indicate the flex draper 25 is going into a ground depression such as a hole or otherwise dropping downwardly due to field undulations and the like, and the positive Differential FAA would indicate the flex draper 25 is coming out of the ground depression or otherwise lifting upwardly due to field undulations and the like.

Preferably, the magnitude of the Differential FAA is monitored relative to an FAA threshold, which represents a set amount of differential change of the float arm to lift leg angle FAA measured in degrees. In the illustrated embodiment, the float arm to lift leg angle FAA threshold may be measured in degrees, such as a 1.5 degree change in the float arm to lift leg angle FAA. The float arm to lift leg angle FAA threshold may be either a positive FAA threshold or a negative FAA threshold, which thereby define upper and lower limits for the Differential FAA. In between the upper and lower limits, there may be a Differential FAA but the magnitude may be low enough so that no system changes are made.

More particularly, if the Differential FAA is a negative value, this negative value typically indicates the flex draper 25 is entering a ground depression, which articulates the four bar linkage in one direction. Conversely, if the Differential FAA is a positive value, this positive value typically indicates the flex draper 25 is leaving or rising from the ground depression, which articulates the four-bar linkage in an opposite direction. As mentioned, in some cases, the upward and downward movements of the flex draper 25 are not significant such that the Differential FAA is relatively small and does not exceed the upper and lower limits of the threshold FAA so that no adjustments are necessary for the float setting FS. However, if the change in ground elevation due to the ground undulation is significant so that the Differential FAA exceeds either the positive FAA threshold or negative FAA threshold, the positive or negative FAA thresholds may be exceeded and the float control system may dynamically adjust the float setting FS to either increase or decrease the ground contact force or in other words, make the effective weight of the flex header 25 heavier or lighter. As noted above, increasing the float setting FS by extending the float cylinder 50 increases the float force that counteracts header weight making ground force lighter, and decreasing the float setting FS would decrease the float force making ground force heavier.

In one example, the float arm to lift leg angle FAA threshold may be set to 1.5 degrees and the Differential FAA is then tested relative to this FAA threshold. The float arm to lift leg angle FAA threshold may be a negative or positive value depending upon whether the Differential FAA is a negative or positive value. In this example, a decrease in float arm to lift leg angle FAA by less than a negative FS threshold, such as −1.5 degrees, makes the float control system shoot for a decrease in the float setting FS by an incremental FS decrease, such as 5%, to decrease the float force and increase the ground weight. This may occur as the flex draper 25 enters a ground depression or hole and thereby causes the flex draper 25 to drop more quickly or with more ground force into the hole to avoid losing ground contact. More specifically, this adjustment in float setting is typically performed when the CMax or contour wheel setting is greater than 30%. Further, this adjustment typically would only be performed if any of the Cmax or contour wheel setting and the lift setting are not changing.

Further, in this example, an increase in float arm to lift leg angle FAA by greater than a positive FAA threshold, such as +1.5 degrees, makes the float control system shoot for an increase in the float cylinder setting by an incremental FS increase, such as 5%, to increase the float force and lighten the ground weight. This adjustment might be performed as the flex draper 25 is rising from or coming out of a ground depression. Here again, this adjustment is performed only if any of the CMax or contact wheel setting or the lift setting are not changing.

Once the Differential FAA is detected as not exceeding the FAA threshold either negatively and/or positively, the float control system can return to the IFS as the ground conditions stabilize.

Next, the weight calibration process uses the calibration curve of FIG. 12B that relates the weight of each of the left and right header sides to the corresponding float arm to lift leg angle FAA when the float cylinders 50 are extended to 100%. The calibration process requires enough spring stiffness in the spring assembly 44 to lift the flex draper 25 off ground with zero lift, zero tilt, and with zero reel fore-aft position and reel height with the header placed in rigid mode, wherein these reel settings are standard settings outside the scope of the present invention. The calibration curve has also been obtained from system's mathematical model.

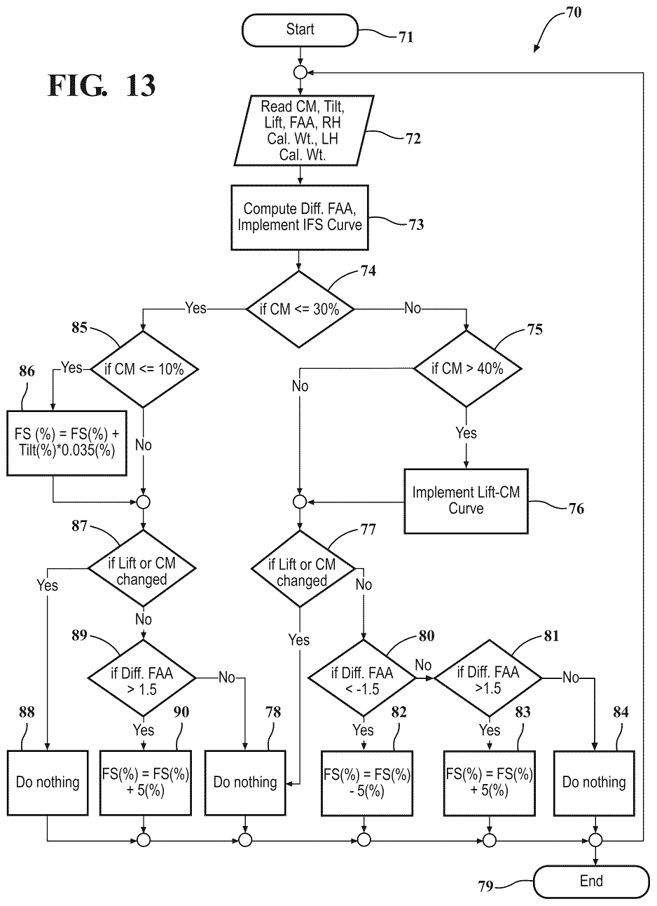

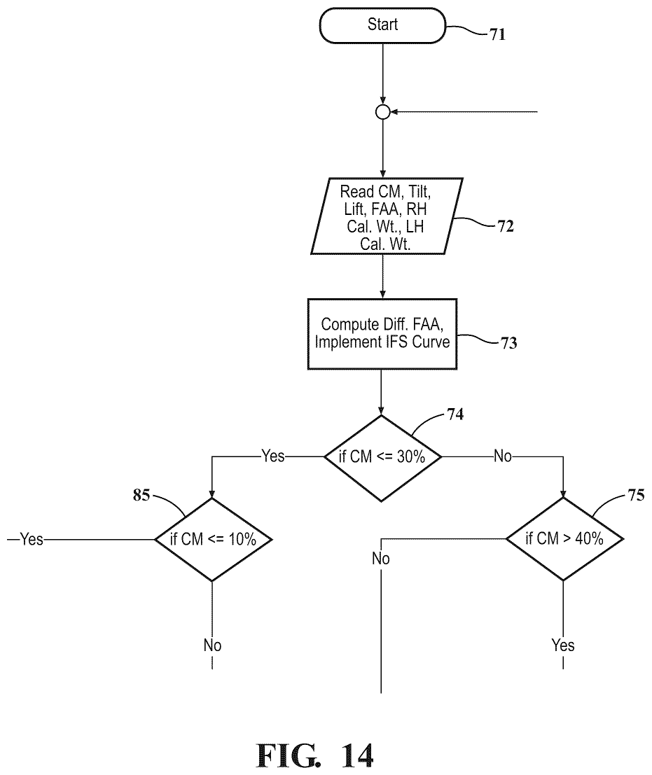

To maintain automatic adjustment of the float setting during field operations, the process of the inventive control system 70 is illustrated in FIGS. 13-16 wherein the control process starts at step 71 and performs the data collection step 72 to read and monitor the contour wheel setting (CM), which defines the cutter bar height relative to ground elevation 36, the tilt setting governing the tilt of the header by the center link 35, the lift setting of the lift cylinder 33, and the float arm to lift leg angle FAA, which performs multiple functions including monitoring of the geometry of the four bar linkage and the dynamic changes thereon during field operations.

Referring to FIGS. 13 and 14, in Step 72, the control system also may perform a weight calibration process for the right hand (RH) and left hand (LH) sides of the flex draper 25. In typical use, the structural configuration and weight distribution of the flex draper 25 can vary depending upon the addition, removal or replacement of components and accessories, which can vary the header weight W, center of gravity G and the weight distribution between the left and right sides. The header weight characteristics may also change depending upon the model of a flex draper 25 and the size thereof, which can be vary from model of the flex draper 25 illustrated in FIG. 6. Since the windrower 10 may be used with different headers 24 and flex drapers 25, the weight characteristics encountered by the float control system can vary. Accordingly, the float control system preferably calibrates the calculated weight for the left and right sides, which can be done periodically when structural changes occur or when starting field operations at the beginning of season or even when moving fields.

The weight calibration process uses a calibration curve as seen in FIG. 12B for each of the left and right header sides that relates the weight of each side of the flex draper 25 to the corresponding float arm to lift leg angle FAA when the float cylinders 50 are extended to 100%. The calibration process requires enough spring stiffness to lift the header 25 off of the ground with zero lift and zero tilt, and with the reel fore-aft position and reel height for any header reel placed in rigid mode. The calibration curve has been obtained from the float control system's mathematical model. In these conditions, the float arm angle FAA is lower under heavier header weights, and is greater under lighter header weights, such that the magnitude of the measured float arm angle FAA can thereby indicate the weight of the left or right header side using the calibration curve 12B depending upon which side the angle-measuring potentiometer 58 (FIG. 7) is located. Since the float arm to lift leg angle FAA is measured and monitored by potentiometers 58 or other types of indicator sensors on both of the left and right sides, each side can be independently calibrated and the weight of each side calculated or determined from the calibration curve 12B. This calibration process in Step 72 thereby calibrates the particular flex draper 25 being used relative to the existing float spring configuration. The calibrated weight for each side thereby governs the selection of one of the ideal float setting curves that corresponds to the calculated weight as described above.

In Step 73, the float control system computes the differential float arm to lift leg angle FAA for each of the left and right sides as measured by the detected float arm angles FAA, and also selects the appropriate optimal float setting curve IFS for each side of the header based on the calibrated weight of that header side that is determined in Step 72 using the weight calibration process. The optimal float setting curve thereby allows calculation of an ideal float setting IFS, which may be applied as an actual float setting FS applied to the spring assemblies 44 by the float cylinder 50.

In this Step 73, the Differential FAA indicates dynamic changing of the float arm angles FAA over time during field operations and may reflect the rate or magnitude of change over incremental or sequential measurement periods. Further, the Differential FAA may be positive or negative as described above to indicate exiting or entering of ground depressions like a valley. During the field operations, the actual float setting FS is maintained but field conditions are monitored and evaluated by monitoring the Differential FAA in the event the float setting FS should be adjusted.

In Step 74, the process evaluates the contour wheel setting (abbreviated as CM) to determine the magnitude of header lift generated by the contour wheel actuators 56A, which may be configured as the hydraulic cylinder 56B. If the contour wheel setting CM is not less than or equal to a first CM threshold of a defined percentage, in this case 30% of maximum lift, the process further tests this CM or contour wheel setting to determine if it exceeds a second CM threshold, in this case 40% in Step 75. The first and second thresholds reflect different performance characteristics of the flex draper 75 and the structural configuration and geometry thereof.

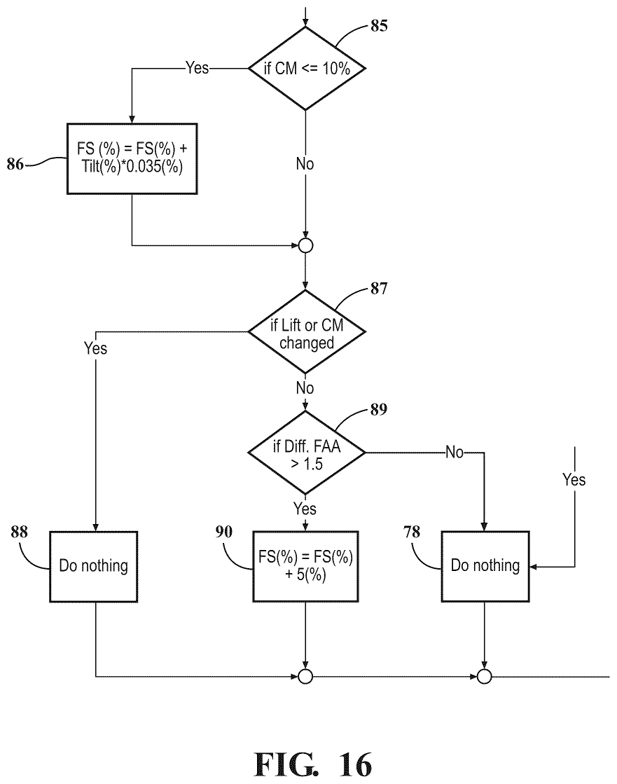

In more detail, when the contour wheel setting CM is less than 30%, the center of gravity G and/or center of rotation O of the four bar linkage are located in positions such that the flex draper 25 tends to increase in ground weight or gets heavier which tends to drop the flex draper 25 into the depression more quickly to maintain ground contact. Thus, dynamic adjustment of the float setting FS is handled with a first subroutine shown in FIGS. 14 and 16 if the contour wheel setting is less than or equal to the first CM threshold as tested in Step 74.

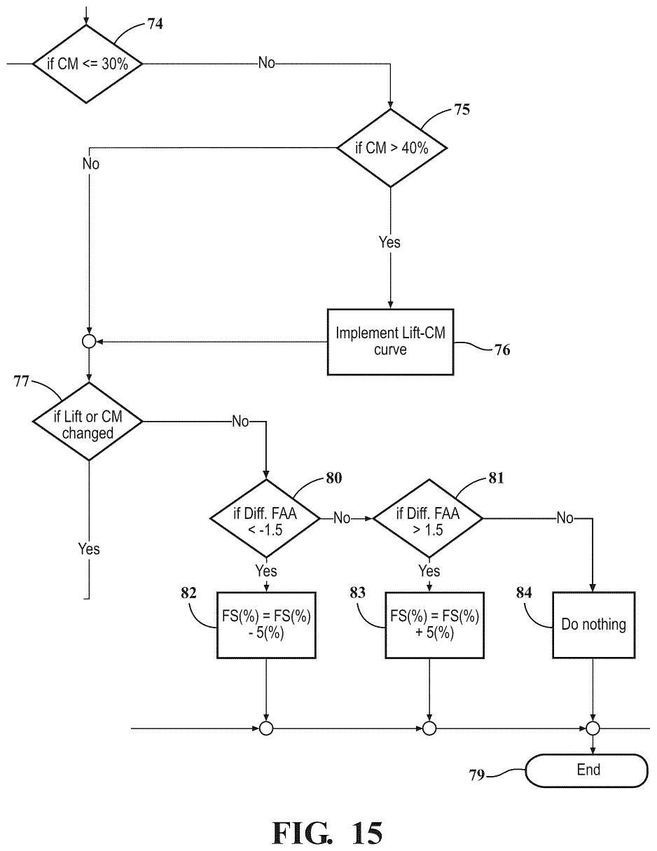

However, as the contour wheel setting CM increases above the first CM threshold, the flex draper 25 tends to be lighter or has less ground weight due to shifting of the boots 34 and the virtual center O of the four-bar linkage as the contour wheels 56 lift the flex draper 25, such that the dynamic float adjustment is performed using a second subroutine or set of process steps (FIG. 15) when the contour wheel setting exceeds the first CM threshold after Step 74. Further, as determined in Step 75, once the contour wheel setting exceeds a second threshold, such as 40% in this geometry, the flex draper system moves away from the preferred middle of the float such that additional process steps are performed using the Lift_Cmax curve of FIG. 12A.

In more detail as to FIGS. 13 and 15, exceeding the second threshold in Step 75 causes the float control process to implement the Lift-Cmax contour wheel curve of FIG. 12 A in Step 76 which evaluates the lift setting and contour wheel setting relative to the predefined Lift-Cmax curve (FIG. 12A) and then adjusts the lift of the flex draper 25 using the Lift-Cmax curve to avoid exceeding the middle of the float by much. The lift may be adjusted by either the lift cylinders 33 and/or contour wheel actuators 56B based upon the dictates of the Lift-Cmax curve in Step 79.

If the lift setting or contour wheel setting is determined to have been changed in Step 77, the float control system passes to the Do Nothing Step 78 (i.e., bypass step) shown in FIG. 16 to bypass further evaluation, move to the end Step 79 and then return to the data collection Step 72 for a next iteration of the dynamic float control process. While the change in lift may result from automatic or dynamic changes resulting from process Step 76, these changes may also be directed by the operator from the cab controls during before or during field operations. Since the change in lift typically affects other settings or variables such as the float arm to lift leg angle FAA, the data collection of Step 72 is again performed to allow detection of the contour wheel setting, the lift setting and the float arm to lift leg angle FAA and perform recalculation of the Differential FAA in Step 73 and implementation of the Ideal Float Setting curve if appropriate wherein changes in the contour wheel setting would change the float cylinder setting or CM as described above.

Turning back to Step 76, once no changes in lift are detected, whether the changes result from operator controls or from implementation of the Lift-Cmax curve at Steps 76 and 77, the float setting FS is then evaluated further in Steps 80 and 81 to evaluate the Differential FAA and determine whether adjustments to the float setting FS are desired.

In Step 80, if the Differential FAA is a negative value that is less than a negative value of the FAA threshold for the float arm to lift leg angle FAA, such as −1.5 degrees, this indicates the flex draper 25 is entering a ground depression such as a hole with a magnitude of change that dictates adjustment of the FAA. In this instance, the dynamic float control system adjusts to increase the ground weight to maintain ground contact by decreasing the float setting FS. In particular, in this instance, the actual float setting FS is decreased in Step 82 by an incremental step decrease, such as 5%, to decrease the float preload and increase the ground weight.

Or else in Step 81, if the Differential FAA is a positive value that is greater than the positive value of FAA threshold of the float arm to lift leg angle FAA, such as +1.5 degrees, this indicates the flex draper 25 is exiting the ground depression such that the actual float setting FS is increased in Step 83 by an incremental step increase, such as 5%, which increases the float preload and decreases the ground weight. For these cases, the actual float setting FS may be decreased one or more times as the flex draper 25 enters the ground depression and may be increased one or more times as it exits the ground depression, wherein the float control process loops through the Steps 80 and 81. Or in neither case, when it is determined by Steps 80 and 81 that the Differential FAA is within the range defined by the positive and negative values of the FAA threshold for the float arm to lift leg angle FAA, i.e., −1.5<Differential FA <+1.5, the process passes to the Do Nothing Step 84 and returns to Step 72 for the next process iteration or loop.

The magnitude of the FAA threshold, whether positive or negative, effectively defines the sensitivity of the system to changes in the float arm angle FAA. The FAA threshold may vary to increase or decrease the system sensitivity. Further, while the incremental step changes are preferably set at +or −5%, the magnitude of the step change may be larger or smaller. These values may be preset in the float control system or may be adjustable values set by the operator through manual cab controls.

Considering again the contour wheel setting evaluation performed at Step 74 (FIGS. 13, 14 and 16), if the contour wheel setting is determined to be less than or equal to the first CM threshold, such as 30% in this case, the process then moves to the first subroutine and evaluates in Step 85 whether the contour wheel setting is less than or equal to a minimum CM or contour wheel threshold of a defined percentage, such as 10%. Below this minimum contour wheel threshold, it has been found that the header tilt generally affects the cutterbar 52 acting on the ground elevation 36. In this instance, the percentage float of the float setting FS in Step 86 is adjusted by a tilt adjustment that preferably is a percentage or fraction of the tilt setting (defined in percentage), wherein the tilt adjustment is added to the current float setting FS to calculate an adjusted float setting FS that is increased so as to increase the float preload and thereby minimize cutterbar affects. If the contour wheel setting is greater than the minimum CM threshold, the header tilt is considered to have a negligible affect and tilt adjustment Step 86 is bypassed or skipped.

Once tilt adjustment Step 86 is performed and if the contour wheel setting exceeds the minimum CM threshold, the float control process then performs Step 87 to determine whether the lift setting or contour wheel setting have been changed, and if so, the control system passes to the Do Nothing Step 88 (i.e. bypass step) to bypass further evaluation, move to the end Step 79 and then return to Step 72 for a next iteration of the process. In this regard, the change in lift or contour wheel CM setting may be due to the operator making such an adjustment, such that a change in Differential FAA would not be due to field conditions. Since the change in lift or contour wheel settings typically affects other settings and variables, the data collection of Step 72 is again performed to allow detection of the contour wheel setting, lift setting and float arm to lift leg angle FAA and recalculation of the Differential FAA and implementation of the appropriate Float Setting curve.

In Step 87, if there is no change in lift or contour wheel settings, the Differential FAA is then evaluated in Step 89 as to whether it exceeds a positive value for the float arm to lift leg angle FAA threshold, such as +1.5. If so, the float setting FS is increased by the incremental adjustment, such as 5%, in Step 90 to set an increased FS setting to reduce the ground weight of the header, after which the process returns to the data collection of Step 72. Essentially, the float control process tests whether the flex draper 25 is rising or climbing out of a ground depression as indicated by the positive value for the float arm to lift leg angle FAA threshold. Or else if the Differential FAA does not exceed this threshold amount, the process passes to the Do Nothing Step 78 and returns to the data collection of Step 72 for successive iterations of the automatic float control system. In this condition, when the contour wheel CM setting is less than the first threshold, the header weight tends to increase in ground weight as a natural result of the geometry, such that the float control process preferably does not check the Differential FAA against the negative FAA threshold. As such, it is preferred that Step 89 only tests if the flex draper 25 is coming out of a ground depression or hole and does not test for whether it is going into the ground depression.

In summary, the float control system of the present invention preferably includes different types of control curves that are used in one aspect to adjust the lift of the flex draper 25 using a Lift-Cmax or Contour wheel curve to avoid exceeding the middle of the float range by a significant amount. Further, the control curves also govern adjustment of the optimal float setting based on the appropriate optimal float setting curves, the header tilt, and the float arm to lift leg angle 53 according to the control logic described herein. Preferably, the Lift-Cmax or Contour Wheel curve and the Optimal Float Setting curves are integrated into the float control system, such by storage on a storage media or by calculation through a processor, and typically are obtained from the float control system's mathematical model that is incorporated into the windrower operating system. As the float setting is determined and/or adjusted during field operations, the float cylinder 50 is operated to dynamically adjust the tensioner or spring assembly 44 and the float preload set thereby. As such, system changes can be monitored using the float arm angle FAA and can be adjusted dynamically by automatically adjusting the float setting and float preload depending on the Differential FAA detected by the float control system.

Considering the above, the absence of the inventive float control system in a flex draper 25 would essentially preclude use of a flex draper 25 on a windrower 10 due to the operating requirements of such flex draper 25. However, the inventive float control system allows use of the flex draper 25 on the windrower 10, which provides advantages over other types of headers that were previously used in such agricultural applications. The operation of the flex draper 25 on the windrower 10 improves the performance of windrowing operation such as by reducing the amount of crop that might be lost through land undulations and by maintaining a preferred stubble height for better seed bed preparation for the following year.

Although a particular preferred embodiment of the invention has been disclosed in detail for illustrative purposes, it will be recognized that variations or modifications of the disclosed apparatus, including the rearrangement of parts, lie within the scope of the present invention.

1. A windrower operating system for a header mounted on a windrower, comprising:
at least one float linkage, which is fixed on a windrower frame and includes a plurality of articulating float links supporting said header to permit floating upward and downward movements of said header relative to said windrower;
a float assembly connected to said float linkage, which comprises a spring tensioner that generates a resilient float force that biases said float linkage upwardly to an initial float position to carry most of a header weight of said header and thereby control a ground force of said header acting on a ground elevation, said spring tensioner being connected to a float actuator which adjusts said float force to a float setting that sets said float force with said float linkage in an initial float position, said spring tensioner being configured to decrease and increase said float force generated thereby in response to floating upward and downward movements of said header;
an indicator sensor on said float linkage which senses an articulation of said links and generates a sensor signal indicating an amount of said articulation of said links during upward and downward movements of said header; and
a float control system which monitors said indicator sensor and said articulation of said links and adjusts said float setting when detecting said articulation of said links to define an optimal float setting for said float force.

2. The windrower operating system according to claim 1, wherein said articulating links of said float assembly define a four-bar linkage having a lift leg carrying said header and said indicator sensor detects changes in a geometry of said four-bar linkage during upward and downward movements of said lift leg and said header.

3. The windrower operating system according to claim 1, wherein said articulating links of said float assembly define a four-bar linkage defined by a frame support on said windrower, a lift leg spaced from said frame support, a float arm pivotally connected between said frame support and said lift leg, and a lift actuator also pivotally connected between said frame support and said lift leg wherein said lift leg carries said header with said float assembly acting on said four-bar linkage to resist downward movement of said lift leg and said header supported thereon.

4. The windrower operating system according to claim 3, wherein said lift leg and said float arm are pivotally connected together to define a float arm to lift leg angle therebetween which varies with upward and downward movements of said lift leg and said header, said indicator sensor monitoring and detecting said float arm to lift leg angle and said float control system adjusting said float setting based upon changes in said float arm to lift leg angle during operation of said header in a field.

5. The windrower operating system according to claim 1, wherein said float control system increases said float setting and said float force resulting therefrom when sensing that said sensor signal indicates an upward movement of said lift leg and said header.

6. The windrower operating system according to claim 1, wherein said float control system decreases said float setting and said float force resulting therefrom when sensing that said sensor signal indicates a downward movement of said lift leg and said header.

7. The windrower operating system according to claim 6, wherein said header is a flex draper comprising a plurality of draper segments flexibly joined together wherein said draper segments are supported on the ground elevation by one of skid shoes, a cutterbar wearplate or height-adjustable contour wheels, said contour wheels being located to follow said ground elevation and variations therein and including respective contour wheel actuators for raising said flex draper segments vertically relative to said contour wheels over a lift range to set a height of said flex draper based upon a contour wheel setting of said contour wheel actuators, said ground force changing in dependence upon said contour wheel setting and said height of said flex draper wherein said float control system monitors said contour wheel setting and adjusts said float setting based upon said contour wheel setting to account for variations in said ground force resulting from changes in said contour wheel setting.

8. A windrower having a windrower operating system for a header mounted on said windrower, said windrower comprising:
at least one float linkage, which is fixed on a windrower frame and includes a plurality of articulating links supporting said header to permit floating upward and downward movements of said header relative to said windrower, said articulating links comprising at least a pivotal float arm connected to said windrower and a lift leg pivotally connected to said float arm at an orientation defining a float arm to lift leg angle therebetween, wherein said lift leg carries said header and said float arm to lift leg angle changes as said header moves upwardly and downwardly;
a float assembly connected to said float linkage, which has a spring tensioner that generates a resilient float force that biases said float linkage upwardly to an initial float position to carry most of a header weight of said header and thereby control a ground force of said header acting on a ground elevation, said spring tensioner being configured such that floating upward and downward movements of said header act to decrease and increase said float force generated thereby, said spring tensioner being connected to a float actuator which adjusts said float force to a float setting that sets said float force when said lift leg and said float arm are in said initial position;
an indicator sensor on said float linkage which detects said float arm to lift leg angle and changes therein that indicate an articulation of said links during upward and downward movement of said lift leg and header, said indicator sensor generating a sensor signal indicating an amount of said articulation of said links during said upward and downward movements of said lift leg and said header; and
a float control system which monitors said float arm to lift leg angle detected by said indicator sensor and detects changes in said float arm to lift leg angle indicating said articulation of said links, said float control system further controlling said float actuator to adjust said float setting when detecting said articulation of said links to adjust said float force.

9. The windrower according to claim 8, wherein said articulating links of said float assembly define a four-bar linkage defined by a frame support on said windrower, said lift leg spaced from said frame support, said float arm connected between said frame support and said lift leg, and a lift actuator also connected between said frame support and said lift leg wherein said lift leg carries said header with said float assembly acting on said four-bar linkage to resist downward movement of said lift leg and said header supported thereon.

10. The windrower according to claim 9, wherein changes in a geometry of said four-bar linkage during upward and downward movements of said lift leg and said header changes said float arm to lift leg angle being monitored by said indicator sensor.

11. The windrower according to claim 10, wherein said float control system calculates a differential float arm angle based upon differential changes of said float arm to lift arm angle.

12. The windrower according to claim 11, wherein said float control system increases said float setting and said float force resulting therefrom when said differential float arm angle indicates upward movement of said lift leg and said header.

13. The windrower according to claim 11, wherein said float control system decreases said float setting and said float force resulting therefrom when said differential float arm angle indicates downward movement of said lift leg and said header.

14. The windrower according to 11, wherein said header is a flex draper comprising a plurality of draper segments flexibly joined together and wherein said draper segments are supported on the ground elevation by at least one of height-adjustable contour wheels and ground-following support structures on said flex draper, said contour wheels being located to follow said ground elevation and variations therein and including respective contour wheel actuators for raising said flex draper segments vertically relative to said contour wheels over a lift range to set a height of said flex draper based upon a contour wheel setting of said contour wheel actuators, said ground force changing in dependence upon said contour wheel setting and said height of said flex draper wherein said float control system monitors said contour wheel setting and adjusts said float setting based upon said contour wheel setting to account for variations in said ground force resulting from changes in said contour wheel.

15. The windrower according to claim 14, wherein said draper segments comprise a center segment and left and right side segments, and said float control system uses said float arm to lift leg angle to calculate said header weight on at least one of said left and right side segments wherein said float arm to lift leg angle varies depending upon said header weight.

16. The windrower according to 11, wherein said header is a flex draper comprising a plurality of draper segments flexibly joined together and wherein said draper segments are supportable on the ground elevation by skid shoes on said draper segments or cutterbar wearplates on a cutterbar provided on said flex draper wherein said flex draper follows said ground elevation.

17. The windrower according to claim 16, wherein said draper segments comprise a center segment and left and right side segments, and said float control system uses said float arm to lift leg angle to calculate said header weight on at least one of said left and right side segments wherein said float arm to lift leg angle varies depending upon said header weight.

18. A method for controlling a float control system for a header mounted on an agricultural vehicle, said header being supported on at least one float linkage, which is fixed on a vehicle frame and includes a plurality of articulating links supporting said header to permit floating upward and downward movements of said header relative to said vehicle, said articulating links comprising at least a pivotal float arm connected to said vehicle and a lift leg pivotally connected to said float arm at an orientation defining a float arm to lift leg angle therebetween, wherein said lift leg carries said header and said float arm to lift leg angle changes as said header moves upwardly and downwardly, said method comprising the steps of:
providing a float assembly connected to said float linkage, which has a spring tensioner that generates a resilient float force that biases said float linkage upwardly to an initial float position to carry most of a header weight of said header and thereby control a ground force of said header acting on a ground elevation, said spring tensioner being configured such that floating upward and downward movements of said header act to decrease and increase said float force generated thereby;
adjusting a float actuator connected to said spring tensioner by said float control system to adjust said float force to a float setting that sets said float force when said lift leg and said float arm are in said initial position;
monitoring said float arm to lift leg angle and changes therein as indicated by an indicator sensor on said float linkage;
detecting an articulation of said float arm and lift leg relative to each other during upward and downward movement of said lift leg and header by sensing differential changes in said float arm to lift leg angle;
generating a differential float arm angle which is the difference in readings of said float arm to lift leg angle over time that indicates an amount of said articulation of said links during said upward and downward movements of said lift leg and said header; and
controlling said float actuator to adjust said float setting when detecting said articulation of said links to adjust said float force.

19. The method according to claim 18, wherein said controlling of said float actuator increases said float setting and said float force resulting therefrom when said differential float arm angle indicates upward movement of said lift leg and said header.

20. The method according to claim 18, wherein said controlling of said float actuator decreases said float setting and said float force resulting therefrom when said differential float arm angle indicates downward movement of said lift leg and said header.

21. The method according to claim 18, wherein said header is a flex draper comprising a plurality of draper segments flexibly joined together and wherein said draper segments are supported on the ground elevation by height-adjustable contour wheels, said contour wheels being located to follow said ground elevation and variations therein and including respective contour wheel actuators for raising said flex draper segments vertically relative to said contour wheels over a lift range to set a height of said flex draper based upon a contour wheel setting of said contour wheel actuators, said ground force changing in dependence upon said contour wheel setting and said height of said flex draper, said method further including the steps of monitoring said contour wheel setting and adjusting said float setting based upon said contour wheel setting to account for variations in said ground force resulting from changes in said contour wheel setting.

22. The method according to claim 21, further including the steps of determining of said contour wheel setting exceeds a threshold setting above which said header is raised to a height which reduces said ground force by virtue of an increase in height of said flex draper relative to said ground elevation; and
wherein, when said contour wheel setting exceeds said threshold setting, said controlling of said float actuator decreases said float setting and said float force resulting therefrom when said differential float arm angle indicates downward movement of said lift leg and said header increases said float setting and said float force resulting therefrom when said differential float arm angle indicates upward movement of said lift leg and said header.

23. The method according to claim 21, wherein said draper segments comprise a center segment and left and right side segments, and said method comprises the step of calculating said header weight on at least one of said left and right side segments using said float arm to lift leg angle, which varies in correlation with said header weight.
